(19) United States
(12) Patent Application Publication
(10) Pub. No.: US 2025/0043482 A1
(43) Pub. Date: Feb. 6, 2025

(54) LAUNDRY TREATMENT APPARATUS

(71) Applicant: LG ELECTRONICS INC., Seoul (KR)

(72) Inventor: Sangin CHUNG, Seoul (KR)

(73) Assignee: LG ELECTRONICS INC., Seoul (KR)

(21) Appl. No.: 18/792,280

(22) Filed: Aug. 1, 2024

(30) Foreign Application Priority Data
Aug. 3, 2023 (KR) 10-2023-0101574

(51) Int. Cl. D06F 33/65; D06F 33/68; D06F 33/70; D06F 34/32; D06F 103/40; D06F 103/68; D06F 105/44

(52) U.S. Cl. CPC D06F 33/65; D06F 33/68; D06F 33/70; D06F 34/32; D06F 2103/40; D06F 2103/68; D06F 2105/44

(57) ABSTRACT

Provided is a laundry treatment apparatus including a cabinet, a drum, a driving unit, a door, a door opening unit moving the door from a closed state to an open state, and a controller controlling the door opening unit. The controller performs one of a plurality of laundry treatment courses by controlling the driving unit to rotate the drum, controls the door opening unit to move the door from the closed state to the open state, when a first course among a plurality of laundry treatment courses is completed, and maintains the door in the closed state, when a second course different from the first course among the plurality of laundry treatment courses is completed.

### CROSS-REFERENCE TO RELATED APPLICATION(S)

This application is based on and claims priority under 35 U.S.C. § 119 to Korean Patent Application No. 10-2023-0101574, which was filed in the Korean Intellectual Property Office on Aug. 3, 2023, the entire disclosure of which is incorporated herein by reference.

### BACKGROUND

### 1. Field

The disclosure relates to a laundry treatment apparatus, and to a laundry treatment apparatus including a door opening part that moves a door from a closed state to an open state.

### 2. Description of Related Art

A laundry treatment apparatus is a device that performs a laundry treatment process, such as removing contamination from laundry by putting clothing, bedding, and so on (hereinafter, referred to as laundry) into a drum.

The laundry treatment apparatus may perform processes such as washing, rinsing, spinning, and drying laundry. Laundry treatment apparatuses may be classified into a top loader type and a front loader type depending on how laundry is into a drum.

The laundry treatment apparatus may include a cabinet including a laundry inlet, a tub accommodated inside the cabinet, a drum rotatably mounted inside the tub and accommodating laundry input through the laundry inlet, a door movably provided on the cabinet and moving according to opening and closing of the laundry inlet, and a detergent supply supplying detergent into the drum.

In the case where the laundry treatment apparatus is provided to wash laundry, when the drum is rotated by a motor while water and detergent are supplied to laundry contained in the drum, dirt on the laundry may be removed by friction between the drum and the washing water.

The detergent supply is equipped with a detergent supply function to enhance the washing effect. Detergent refers to a substance that enhances the washing effect, such as fabric detergent, fabric softener, and fabric bleach. The detergent may be in a powder form or a liquid form.

In the case where the laundry treatment apparatus is provided to dry laundry, the laundry treatment apparatus may remove moisture from the laundry by providing dry air to the laundry.

The laundry treatment apparatus may be configured to include the cabinet, the drum rotatably provided inside the cabinet, and a heater for heating or drying air provided to laundry.

As dry air is supplied to the laundry contained in the drum, moisture may be evaporated from the laundry by the dry air, thereby removing the moisture from the laundry.

When the door is not opened after completion of a laundry treatment process such as washing or drying in the above laundry treatment apparatus, problems may occur, such as bad odor caused by bacterial growth in laundry after washing, and wrinkles in the laundry after drying.

A relevant document KR 10-2022-0164591 discloses a laundry treatment apparatus including a door opening part. After a laundry treatment course is completed, the door opening part may move a door to the open state to prevent odor from laundry. However, when the door is automatically opened after drying, heated air in a drum leaks to the outside, which may cause safety issues or affect the temperature of external air.

Therefore, it is preferable for safety as well as user convenience to disable an automatic door opening function after drying and recommend a user to open the door.

In addition, even if the door is automatically opened, when the opening is not indicated to the user by a notification, the user may not recognize the completion of laundry treatment and thus leave the laundry in the laundry treatment apparatus for long.

Moreover, when a care course for caring processed laundry is added after a laundry treatment course, the door opening part may need to maintain the door in the closed state, and output a message notifying opening of the door after a message notifying that the care course is in progress.

As a consequence, a different care course may be performed for each laundry treatment course, and the user may clearly recognize an ongoing care course and then complete laundry treatment by checking whether the door is open.

Accordingly, it is an important issue in the technical field of the disclosure to distinguish laundry treatment courses from each other, make different settings regarding whether to operate the door opening part for different laundry treatment courses, and output an appropriate message in consideration of whether the door opening part operates and the progress of an additional care course in the laundry treatment apparatus, which ensures the user's safety and increases satisfaction with laundry treatment.

### SUMMARY

Embodiments of the disclosure provide a safe laundry treatment apparatus by allowing a different setting regarding whether to operate a door opening part for each laundry treatment course.

Embodiments of the disclosure provide a laundry treatment apparatus that increases satisfaction with laundry treatment by notifying a user whether a door has been opened after a laundry treatment course is completed.

Embodiments of the disclosure provide a laundry treatment apparatus that increases satisfaction with laundry treatment by outputting a message notifying that a door has been opened by a door opening part after a course is completed.

Embodiments of the disclosure provide a laundry treatment apparatus that increases satisfaction with laundry treatment by outputting a different message according to a user's setting regarding whether to operate a door opening part.

Embodiments of the disclosure provide a laundry treatment apparatus that increases satisfaction with laundry treatment by notifying whether a door has been open after a message notifying that a care course is in progress, when an additional care course is performed after a laundry treatment course.

In a laundry treatment apparatus according to an embodiment of the disclosure, a controller performs one of a plurality of laundry treatment courses, controls a door opening part to move a door from a closed state to an open state, when a first course among the plurality of laundry treatment courses is completed, and maintains the door in the closed state, when a second course different from the first course among the plurality of laundry treatment courses is completed.

Then, an output part outputs a message notifying a user of the open state or the closed state of the door by the door opening part, thereby increasing the user's satisfaction with laundry treatment.

A laundry treatment apparatus according to an embodiment of the disclosure includes a cabinet, a drum, a driving part, a door, a door opening part, and a controller.

The cabinet includes a laundry inlet, the drum is provided inside the cabinet and accommodates laundry input through the laundry inlet, and the driving part is connected to the drum and provides rotational force to the drum.

The door is provided movably in the cabinet and moved to correspond to one of a closed state in which the laundry inlet is closed and an open state in which the laundry inlet is open, and the door opening part is provided in the cabinet and moves the door from the closed state to the open state.

The controller is provided inside the cabinet to control the door opening part, and performs one of a plurality of laundry treatment courses by controlling the driving part to rotate the drum.

With whether to operate the door opening part for the first course set by a user, the controller may control the door opening part to move the door to the open state after the first course is completed.

The controller may be provided to allow the user to set whether to operate the door opening part for the first course, and may maintain the door in the closed state after the second course is completed.

The plurality of laundry treatment courses may include a wash course for washing laundry and a dry course for drying laundry, the first course may correspond to the wash course, and the second course may correspond to the dry course.

The plurality of laundry treatment courses may further include a wash and dry course for successively washing and drying laundry, and the second course may correspond to the dry course or the wash and dry course.

After one of the plurality of laundry treatment courses is completed, the controller may selectively perform a care course for caring laundry processed by the one laundry treatment course, and when the care course is performed after the first course, the controller may perform the care course, while maintaining the door in the closed state after the first course is completed, and move the door to the open state after the care course is completed.

A plurality of care courses may be stored in the controller, one of the plurality of care courses may be available only after the first course, and another one may be available after the first course or the second course is completed.

The one of the plurality of care courses may correspond to a laundry care course including a rinse cycle for the laundry after the first course is completed.

The other one of the plurality of care courses may correspond to a wrinkle suppression course suppressing wrinkles of the laundry by rotating the drum after the first course or the second course is completed.

Among the plurality of care courses, the one and other care courses may be successively performed after the first course.

The plurality of care courses may include a laundry care course including a rinse cycle for the laundry and a wrinkle suppression course suppressing wrinkles of the laundry by rotating the drum, the one care course may correspond to the laundry care course, and the other care course may correspond to the wrinkle suppression course.

The door may be provided movably in the cabinet and rotatingly move from the open state to the closed state.

The door opening part may include a base fixed to the cabinet and a protrusion of a variable length protruding from the base toward the door, and the controller may control the door opening part to move the door to the open state by increasing the length of the protrusion in the closed state of the door.

The laundry treatment apparatus may further include an output part provided in the cabinet and outputting a screen. When the door is moved to the open state by the door opening part, the controller may control the output part to output an open message notifying the user of the open state, and when the door is maintained in the closed state, the controller may control the output part to output a recommendation message recommending the user to open the door.

The laundry treatment apparatus may further include an input part provided in the cabinet and generating an input signal by being manipulated by the user. The output part may output a settings object D102 selected based on the input signal, and upon selection of the settings object D102, output a settings screen displaying a plurality of setting items. The plurality of setting items may include a setting item for setting whether to operate the door opening part.

When the door opening part is set to be inoperable for the first course, the output part may output a message recommending the user to set the door opening part to an operable state.

The controller may perform one of a first mode in which the first course is available and a second mode in which the second course is available, and upon selection of the setting item for setting whether to operate the door opening part in the second mode, the output part may output a message notifying the user that the door opening part is inoperable in the second mode.

The controller may selectively perform a care course for caring the laundry processed by one of the plurality of laundry treatment courses, and the output part may output a message notifying that the care course is in progress during the care course, and the open message or the recommendation message after the care course is completed.

The laundry treatment apparatus may further include an input part provided in the cabinet and generating an input signal by being manipulated by the user, and the output part may output the message notifying that the care course is in progress during the care course. A selection object for stopping the care course may be displayed in the message, for selection through the input part.

Upon selection of the selection object by the input part, the controller may terminate the care course and control the output part to output the open message or the recommendation message.

A laundry treatment apparatus includes a cabinet including a laundry inlet, a drum provided inside the cabinet and accommodating laundry input through the laundry inlet, a door provided movably in the cabinet and moving to correspond to one of a closed state in which the laundry inlet is closed and an open state in which the laundry inlet is open, a door opening part provided in the cabinet and moving the door from the closed state to the open state, and an output part provided in the cabinet and outputting a screen.

When among a plurality of laundry treatment courses for processing the laundry by rotating the drum, a first course is completed, the output part may output an open message notifying a user that the door has been moved to the open state by the door opening part, and when among the plurality of laundry treatment courses, a second course different from the first course is completed, the door may be maintained in the closed state, and the output part may output a recommendation message recommending the user to open the door.

When a care course is performed to care the laundry processed by one of the plurality of laundry treatment courses after the one laundry treatment course is completed, the output part may output the open message, and when a care course performed after completion of the second course is completed, the output part may output the recommendation message.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a first treatment device in a laundry treatment apparatus according to an embodiment of the disclosure;

FIG. 2 is a cross-sectional view illustrating the interior of a first treatment device in a laundry treatment apparatus according to an embodiment of the disclosure;

FIG. 3 is a diagram schematically illustrating a communication relationship of a laundry treatment device according to an embodiment of the disclosure;

FIG. 4 is a perspective view illustrating a first treatment device and a second treatment device in a laundry treatment apparatus according to an embodiment of the disclosure;

FIG. 5 is a front view illustrating a first treatment device and a second treatment device in a laundry treatment apparatus according to an embodiment of the disclosure;

FIG. 6 is a perspective view illustrating a second treatment device in a laundry treatment apparatus according to an embodiment of the disclosure;

FIG. 7 is a cross-sectional view illustrating the interior of a second treatment device in a laundry treatment apparatus according to an embodiment of the disclosure;

FIG. 8 is a diagram conceptually illustrating a control relationship in a laundry treatment apparatus according to an embodiment of the disclosure;

FIG. 9 is a diagram illustrating a control panel in a laundry treatment apparatus according to an embodiment of the disclosure;

FIG. 10 is a conceptual diagram illustrating a process of operating a laundry treatment apparatus according to an embodiment of the disclosure;

FIG. 11 is a diagram illustrating a start screen among screens output from an output part according to an embodiment of the disclosure;

FIG. 12 is a diagram illustrating a course selection screen among screens output from an output part according to an embodiment of the disclosure;

FIG. 13 is a diagram illustrating a course progress screen among screens output from an output part according to an embodiment of the disclosure;

FIG. 14 is a diagram illustrating a message indicating that a door has been moved to an open state by a door opening part after completion of a laundry treatment course according to an embodiment of the disclosure;

FIG. 15 is a diagram illustrating that whether a door is opened by a door opening part is different for each course after completion of laundry treatment, and a corresponding message indicating whether the door is opened is output according to an embodiment of the disclosure;

FIG. 16 is a diagram illustrating that in a dry course, a door is maintained in a closed state after completion of the course and a message recommending a user to open the door is output.

FIG. 17 is a diagram illustrating that in a wash and dry course, a door is maintained in a closed start after completion of the course and a message recommending a user to open the door is output.

FIG. 18 is a diagram illustrating output of an open message after a care course in progress is notified, when the care course is performed after completion of a first course according to an embodiment of the disclosure;

FIG. 19 is a diagram illustrating output of a recommendation message after a care course in progress is notified, when the care course is performed after completion of a second course according to an embodiment of the disclosure;

FIG. 20 is a diagram illustrating output of a message notifying that a plurality of care courses are in progress after completion of a first course according to an embodiment of the disclosure;

FIG. 21 is a diagram illustrating a settings screen on which a settings object is selected and output according to an embodiment of the disclosure;

FIG. 22 is a diagram illustrating output of different messages depending on settings regarding whether to operate a door opening part according to an embodiment of the disclosure;

FIG. 23 is a diagram illustrating output of a notification message, when a door opening part is set to operate for a second course according to an embodiment of the disclosure; and

FIG. 24 is a perspective view illustrating a door opening according to an embodiment of the disclosure.

### DETAILED DESCRIPTION

With reference to the attached drawings, embodiments of the disclosure will be described in detail so that those skilled in the art may easily implement the disclosure.

However, the disclosure may be implemented in various different forms and is not limited to the embodiments described herein. In order to clearly describe the disclosure in the drawings, parts unrelated to the description are avoided, and like reference numerals denote similar components throughout the specification.

In the specification, a redundant description of the same components is avoided.

Further, when it is said that a component is ‘connected’ or ‘coupled’ to another component in the disclosure, it should be understood that the component may be connected to the other component directly or via a third component in between. On the contrary, when it is said that a component is ‘directly connected’ or ‘directly coupled’ to another component in the disclosure, it should be understood that there are no other components in between.

Further, the terms as used herein are merely used to describe specific embodiments and are not intended to limit the disclosure.

Further, in the disclosure, singular expressions may include plural referents, unless the context clearly dictates otherwise.

In the specification, terms such as ‘include’ or ‘have’ are only intended to indicate the existence of features, numbers, steps, operations, components, parts, or combinations thereof described in the specification. It should be understood that this does not exclude the existence or addition of other features, numbers, steps, operations, components, parts, or combinations thereof.

Further, in the specification, the term ‘and/or’ includes a combination of a plurality of listed items or any of the plurality of listed items. In the specification, ‘A or B’ may include ‘A’, ‘B’, or ‘both A and B’.

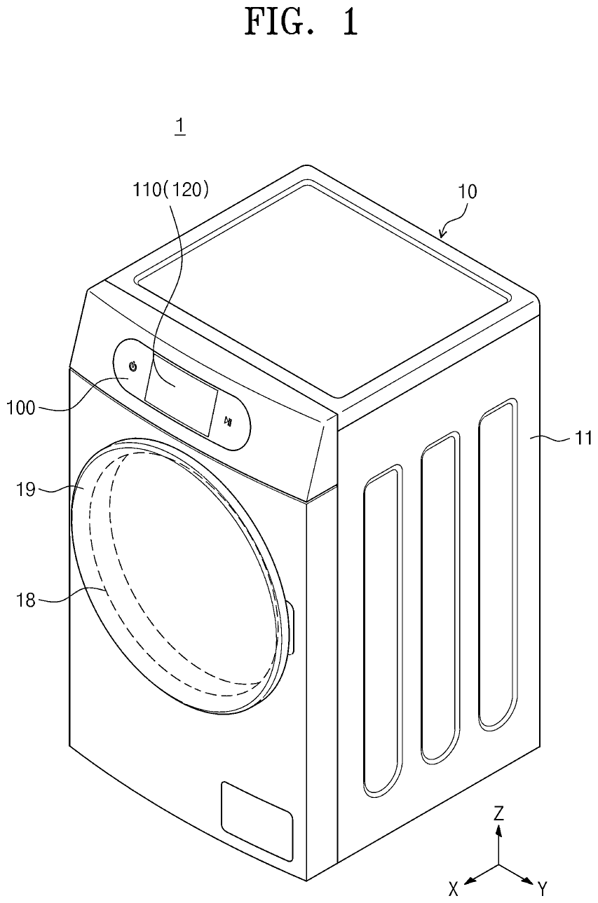

FIG. 1 illustrates a laundry treatment apparatus 1 according to an embodiment of the disclosure. In the disclosure, the laundry treatment apparatus 1 may include a single treatment device or a plurality of treatment devices including a first treatment device 10 and a second treatment device 20.

The laundry treatment apparatus 1 may perform a treatment course for laundry treatment. When the laundry treatment apparatus 1 includes a plurality of treatment devices, the plurality of treatment devices may each perform a treatment course.

In the treatment course, laundry is processed in various ways, such as washing, drying, or removing wrinkles. Laundry put into the treatment apparatus may be processed through the treatment course and provided to a user.

A plurality of different treatment courses may be predetermined and provided to the user, for selection. For example, the plurality of treatment courses may include at least one of a wash course for washing laundry, a dry course for drying laundry, and a wash and dry course for successively washing and drying laundry.

The laundry treatment apparatus 1 according to an embodiment of the disclosure may include a controller 70, and a plurality of treatment courses may be pre-stored in the controller 70 and provided to the user.

A treatment course may include at least one cycle. The treatment course may be defined by including at least one of a water supply cycle, a detergent supply cycle, a wash cycle, a rinse cycle, a drain cycle, a spin cycle, or a dry cycle.

The water supply cycle may be a process of supplying water to a tub into which laundry is put, the detergent supply cycle may be a process of supplying detergent to the tub, the wash cycle may be a process of washing the laundry with the detergent contained in the tub by rotating a drum, the rinse cycle may be a process of washing the laundry by supplying water to the tub and rotating the drum without adding the detergent, the drain cycle may be a process of discharging the water from the tub to the outside of the tub, the spin cycle may be a process of rotating the drum without supplying water to the tub to separate the water from the laundry, and the dry cycle may be a process of removing moisture from the laundry by providing high-temperature dry air into the drum or the tub.

The plurality of treatment courses may be predetermined such that each of the treatment courses has at least one different cycle, and stored in the controller 70. The user may perform laundry treatment by selecting one of the plurality of treatment courses, which suits the user's needs.

FIG. 1 illustrates the first treatment device 10 according to an embodiment of the disclosure. That is, the laundry treatment apparatus 1 illustrated in FIG. 1 is an example of the disclosure, and is configured to include only a single treatment device, that is, the first treatment device 10.

The first treatment device 10 includes a first cabinet 11. The first cabinet 11 may have a space defined inside it and form the exterior of the first treatment device 10.

The first cabinet 11 may include a front panel, a rear panel, side panels, and a top panel. The plurality of panels may be combined with each other to form the first cabinet 11. A first laundry inlet 18 may be formed on one surface of the first cabinet 11, for communication between the outside and inside of the cabinet.

While the first laundry inlet 18 is shown in FIG. 1 as formed on the front panel according to an embodiment of the disclosure, the location of the first laundry inlet 18 is not limited to the front panel.

A first door 19 may be provided to be coupled to the first cabinet 11 and selectively shield the first laundry inlet 18. For example, the first door 19 may be provided to be rotatably coupled to the front panel and shield the first laundry inlet 18 depending on its rotational position.

An embodiment of the disclosure may include a control panel 100. The control panel 100 may include an input part 120 and an output part. However, the input part 120 and the output part are not necessarily provided only on the control panel 100.

The user may identify course setting information or course progress information from information output through the output part, and apply various commands to the controller 70, such as changing course settings, by manipulating the input part 120 and thus generating an input signal. A detailed description will be given later of the control panel 100 and the controller 70.

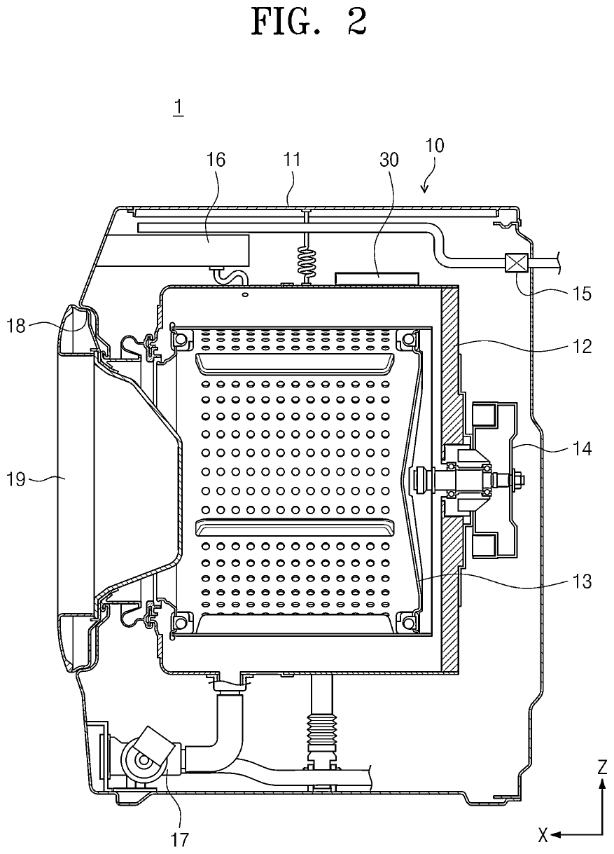

FIG. 2 illustrates the interior of the first treatment device 10. In FIG. 2, the first treatment device 10 is shown as a washer and dryer capable of washing and drying. However, this is only for convenience of description, and the first treatment device 10 is not limited to a washer and dryer.

A first tub 12 and a first laundry container may be provided inside the first treatment device 10 defined by the first cabinet 11. The first tub 12 may be provided inside the first treatment device 10 to accommodate water.

The first tub 12 may include a first tub opening facing the first laundry inlet 18. Accordingly, laundry that the user puts through the first laundry inlet 18 by opening the first door 19 may pass through the first laundry inlet 18 and the first tub opening and be accommodated inside the first tub 12.

The first laundry container may be provided inside the first cabinet 11 and accommodate laundry. The first laundry container may be provided in various forms. For example, the first laundry container may correspond to the form of a basket provided in the first door 19 or a first drum 13 provided inside the first tub 12, and a plurality of first laundry containers may also be provided.

That is, in an embodiment of the disclosure, the first laundry container may include the first drum 13. The first drum 13 may be rotatably provided inside the first tub 12. An embodiment of the disclosure may further include a first driving part 14, and the first drum 13 may be connected to the first driving part 14 and receive rotational force.

Laundry may be accommodated inside the first drum 13. The first drum 13 may include a first drum opening facing the first tub opening. Accordingly, laundry that the user puts in through the first laundry inlet 18 may be accommodated inside the first drum 13 through the first tub opening and the first drum opening.

An embodiment of the disclosure may include a first water supply part 15. The first water supply part 15 may receive water from the outside in a manner such as connection to an external water supply source. The first water supply part 15 may include a water supply hose serving as a water flow path and a water supply valve for controlling the flow of water.

An embodiment of the disclosure may include a first detergent supply part 16. The first detergent supply part 16 may be provided to store detergent, and supply the detergent into the first tub 12 when the detergent is required to perform a laundry treatment course.

FIG. 2 illustrates a structure in which the first water supply part 15 and the first detergent supply part 16 are connected, and water flowing along the first water supply part 15 is supplied together with detergent into the first tub 12 through the first detergent supply part 16. However, the disclosure is not limited to the structure, and the first water supply part 15 may be directly connected to the inside of the first tub 12.

An embodiment of the disclosure may include a first drain part 17. The first drain part 17 may be provided to be connected to the first tub 12 and discharge water from the inside of the first tub 12 to the outside of the first cabinet 11. The first drain part 17 may include a drain hose through which water flows and a drain pump that generates a flow force of water.

In an embodiment of the disclosure, when a wash course for washing laundry is performed, water and detergent may be supplied into the first tub 12 through the first water supply part 15 and the first detergent supply part 16, the laundry may be washed by rotating the first drum 13 by the first driving part 14, and the water and the detergent in the first tub 12 may be discharged to the outside of the first cabinet 11 through the first drain part 17 as needed.

In an embodiment of the disclosure, the first treatment device 10 may include a heating part 30. The heating part 30 may be provided to receive air from the inside of the first drum 13, dehumidify and heat the air, and supply the air back into the first drum 13, or to heat air from the outside of the first cabinet 11 and supply the air into the first drum 13, or to heat air inside the first drum 13.

In an embodiment of the disclosure, the first treatment device 10 may include a door sensing part. The door sensing part may be provided at any of various positions of the first cabinet 11 or the first door 19.

The first door 19 may be provided to be rotatable, and may be rotated in a closed state to contact or come into close contact with the front surface of the first cabinet 11 and close the first laundry inlet 18, and rotated in an open state to move away from the front surface of the first cabinet 11 and open the first laundry inlet 18.

The door sensing part may detect whether the first door 19 has closed the first laundry inlet 18 of the first cabinet 11. Various types of door sensing parts may be provided and detect whether the first door 19 is closed in various ways.

For example, the door sensing part may be provided in the first cabinet 11 or the first door 19 and detect whether the first cabinet 11 and the first door 19 are in contact, thereby detecting whether the first door 19 is closed.

The first treatment device 10 according to an embodiment of the disclosure does not necessarily include the first tub 12, and when needed, the first tub 12 may be omitted. That is, an embodiment of the disclosure is not necessarily limited to a washer, and may be a dryer with the tub removed or a washer and dryer capable of washing and drying.

When an embodiment of the disclosure includes only the first treatment device 10, that is, when it includes only any single treatment device, the first treatment device 10 may be understood as the laundry treatment apparatus 1 itself.

That is, the first cabinet 11, the first tub 12, and the first drum 13 of the first treatment device 10 may be referred to as a cabinet, a tub, and a drum representing the laundry treatment apparatus 1, respectively.

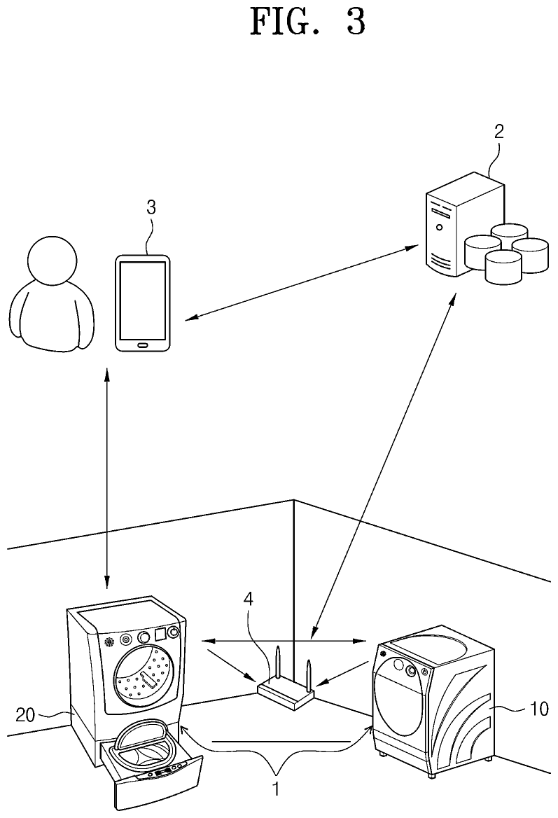

FIG. 3 conceptually illustrates an information exchange method in the laundry treatment apparatus 1 according to an embodiment of the disclosure.

In an embodiment of the disclosure, the first treatment device 10 may be provided to enable communication with the outside. A first communication part for communication in the first treatment device 10 may be provided to enable various types of communication, such as Bluetooth and wireless fidelity (WiFi). However, this does not mean that the first communication part is necessarily provided.

When including the first communication part, the first treatment device 10 may communicate directly with a terminal 3 of a user or communicate with a communication medium 4 disposed outside the laundry treatment apparatus 1. When communicating with the medium 4, the first treatment device 10 may exchange information with a server 2 through the communication medium 4.

The terminal 3 may be any of various devices equipped with communication functionality. For example, the terminal 3 may be any of various devices with communication functionality, such as a mobile phone, a computer, or a tablet PC.

When needed, the first treatment device 10 may exchange information with the terminal 3 through a communication process with the terminal 3, or exchange information with the server 2 through a communication process with the communication medium 4.

Further, the terminal 3 may exchange information with the server 2, and the first treatment device 10 may exchange information with the server 2 through the communication medium 4, so that the first treatment device 10 exchanges information indirectly with the terminal 3.

FIG. 3 illustrates the laundry treatment apparatus 1 including the first treatment device 10 and the second treatment device 20 according to an embodiment of the disclosure. The first treatment device 10 and the second treatment device 20 may be connected wiredly to exchange information, or may exchange information wirelessly as illustrated in FIG. 3.

For example, the first treatment device 10 and the second treatment device 20 may be connected through a direct wireless communication scheme such as Bluetooth to exchange information, may communicate with each other through the communication medium 4, or may be connected indirectly through information exchange with the server 2 through the communication medium 4. The arrangement relationship between the first treatment device 10 and the second treatment device 20 may vary.

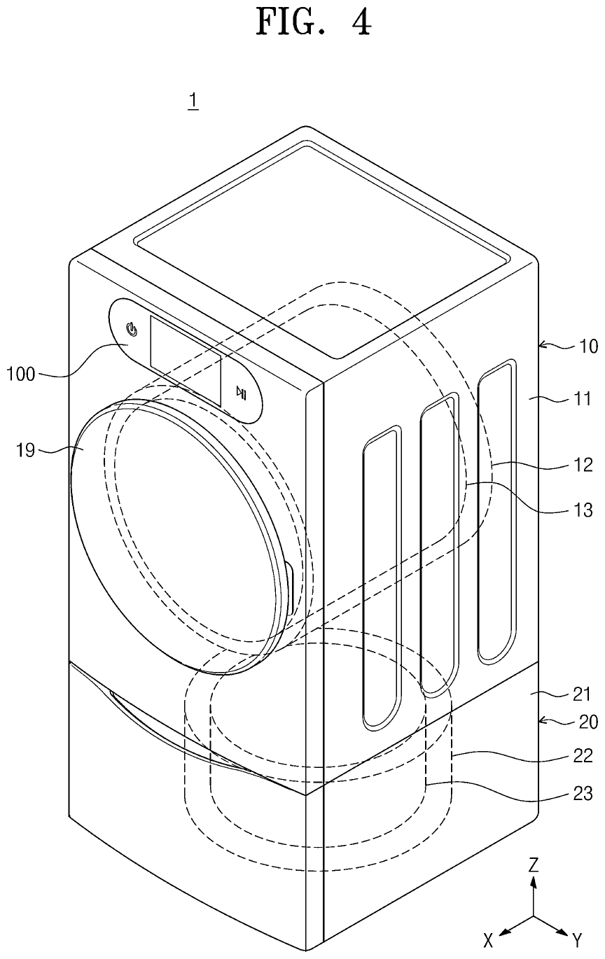

FIG. 4 illustrates the laundry treatment apparatus 1 in which the first treatment device 10 and the second treatment device 20 are stacked. Referring to FIG. 4, an embodiment of the disclosure may include the first treatment device 10 installed on the second treatment device 20.

The first treatment device 10 may include the first cabinet 11, the first tub 12, and the first drum 13 corresponding to the first laundry container, as described above. The second treatment device 20 may include a second cabinet 21, a second tub 22, and a second drum 23 corresponding to a second laundry container, separately from the first treatment device 10.

The first treatment device 10 and the second treatment device 20 may each perform a treatment course for laundry treatment, independently or in conjunction with each other. For example, the first treatment device 10 may perform a first course among a plurality of treatment courses for laundry treatment, and the second treatment device 20 may perform a second course among the plurality of treatment courses.

For convenience of description in the disclosure, a treatment course performed in the first treatment device 10 may be referred to as a first course, and a treatment course performed in the second treatment device 20 may be referred to as a second course. Each of the first course and the second course may be any one of a wash course, a dry course, and a wash and dry course.

For example, the first treatment device 10 may be a washer capable of performing a wash course, and the second treatment device 20 may be a dryer capable of performing a dry course.

Alternatively, each of the first treatment device 10 and the second treatment device 20 may be a washer capable of performing a wash course or a dryer capable of performing a dry course.

Alternatively, at least one of the first treatment device 10 or the second treatment device 20 may be a washer and dryer capable of performing a wash course, a dry course, and a wash and dry course. For example, the first treatment device 10 illustrated in FIG. 4 may be a washer and dryer, and the second treatment device 20 may be a washer.

When the first treatment device 10 or the second treatment device 20 is provided to perform a dry course, it may include the afore-described heater, and when the first treatment device 10 or the second treatment device 20 is provided to perform a wash course, it may include the afore-described detergent supply part and water supply part.

Referring to FIG. 4, in an embodiment of the disclosure, the control panel 100 may be provided in each of the first treatment device 10 and the second treatment device 20, or only in one of the first treatment device 10 and the second treatment device 20.

That is, in an embodiment of the disclosure, one of the first treatment device 10 and the second treatment device 20 may include the control panel 100, and the other may not include the control panel 100. In an embodiment of the disclosure, the first treatment device 10 may include the control panel 100, and the second treatment device 20 may not include the control panel 100.

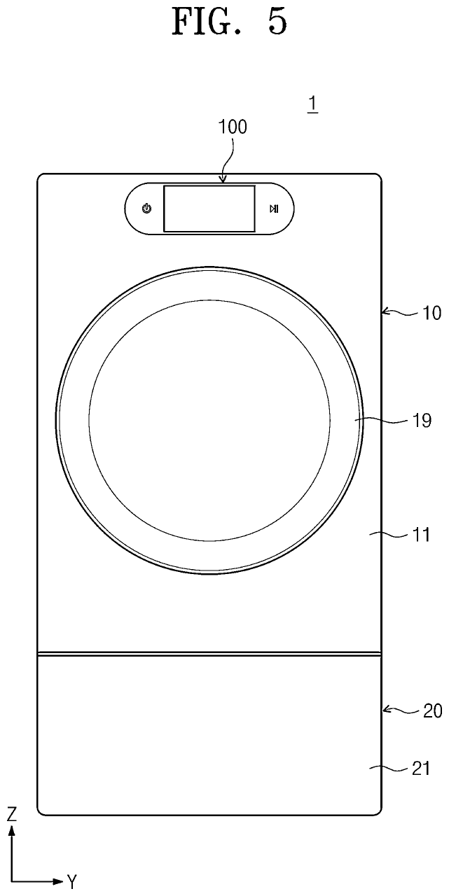

FIG. 5 is a front view illustrating the laundry treatment apparatus 1 of FIG. 4. In an embodiment of the disclosure, the first treatment device 10 may include the first cabinet 11, and the second treatment device 20 may include the second cabinet 21. However, the first treatment device 10 and the second treatment device 20 may be provided inside one integrated cabinet, when needed.

The first treatment device 10 may be disposed on the second treatment device 20. The first treatment device 10 may include the control panel 100, and the second treatment device 20 may not include a separate control panel 100.

The first treatment device 10 may include the first laundry inlet 18 through which laundry is put in, and the second treatment device 20 may include a second laundry inlet 28 through which laundry is put in. However, the first laundry inlet 18 and the second laundry inlet 28 may not always be exposed to the outside.

For example, the first laundry inlet 18 is provided on the front surface of the first treatment device 10 in the laundry treatment apparatus 1 illustrated in FIG. 5, and while not shown, the second laundry inlet 28 may be provided on a top surface of the second treatment device 20. A detailed structure of the second treatment device 20 will be described later.

The first laundry inlet 18 and the first door 19 may be located on the front surface of the first treatment device 10, thereby facing the user. The control panel 100 may be disposed above the first door 19.

In an embodiment of the disclosure, the first treatment device 10 may be larger in volume than the second treatment device 20. That is, the amount of laundry that the first treatment device 10 is capable of processing may be greater than that of the second treatment device 20.

Accordingly, the height of the first treatment device 10 may be greater than the height of the second treatment device 20. The volume of the first drum 13 may be greater than the volume of the second drum 23. The user may select and use either the first treatment device 10 or the second treatment device 20, or use both together, depending on the amount of laundry required to be processed.

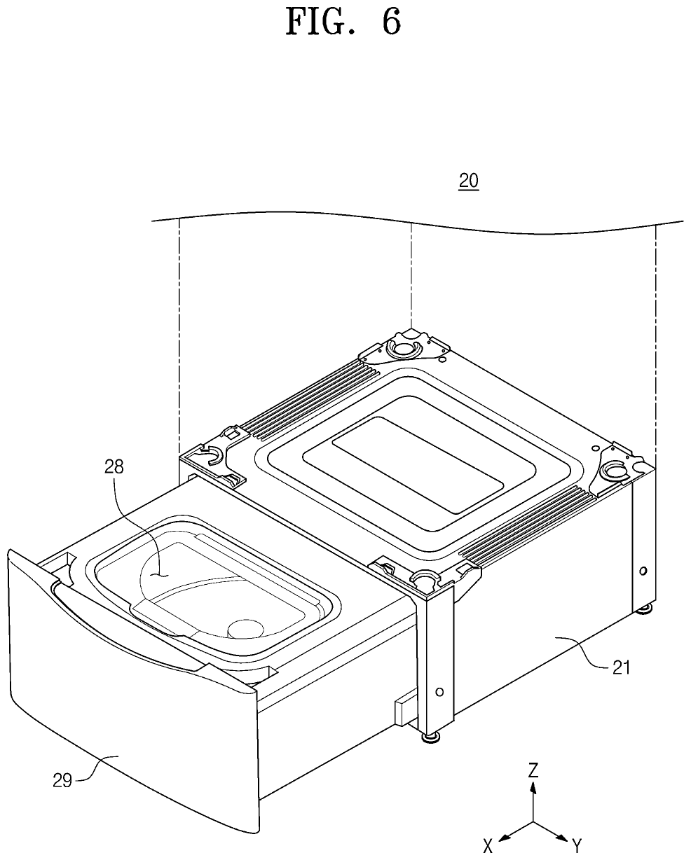

FIG. 6 is a diagram illustrating the second treatment device 20 disposed below the first treatment device 10 in an embodiment of the disclosure.

When the second treatment device 20 is disposed below the first treatment device 10, that is, when the second treatment device 20 is provided to support the load of the first treatment device 10, the second treatment device 20 may be of a front loader type like the first treatment device 10 or may be of a top loader type but include a device drawer 40 which is withdrawn forward from the second cabinet 21.

In FIG. 6, the second treatment device 20 of a type including the device drawer 40 inserted into or withdrawn from the second cabinet 21 is illustrated. The second treatment device 20 may include the second cabinet 21, the device drawer 40, the second tub 22, and the second laundry container.

The second laundry container may be provided inside the second cabinet 21 and accommodate laundry. The second laundry container may be provided in various forms. For example, the second laundry container may correspond to the form of a basket provided in a second door 29 or the second drum 23 provided inside the second tub 22, and a plurality of second laundry containers may be provided.

That is, in an embodiment of the disclosure, the second laundry container may include the second drum 23. A space in which the device drawer 40 is accommodated may be formed inside the second cabinet 21, and the second tub 22 and the second drum 23 may be provided inside the device drawer 40. The second laundry inlet 28 may be provided on the top surface of the device drawer 40 to put in laundry.

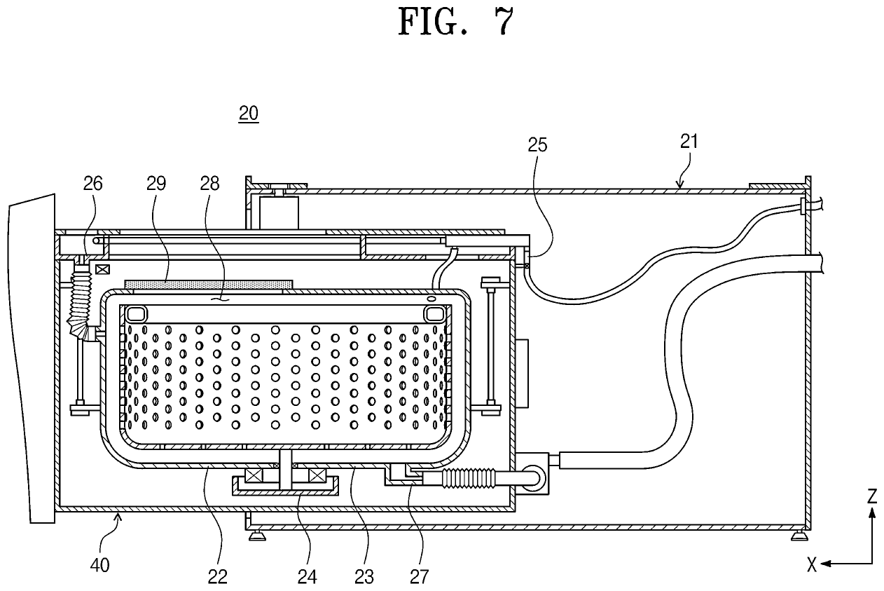

FIG. 7 is a cross-sectional view illustrating the interior of the second treatment device 20 illustrated in FIG. 6. Although the second treatment device 20 is shown in FIG. 7 as a washer capable of washing, this is only for convenience of description and the second treatment device 20 is not limited to a washer.

For example, the second treatment device 20 may be provided in the form of a dryer by omitting the second tub 22 and so on, or may be provided in the form of a washer and dryer by further including a heater. However, for convenience of description, the second treatment device 20 will be described below in the context of the structure illustrated in FIG. 7, unless otherwise specified.

The second treatment device 20 may include the second cabinet 21 and the device drawer 40. The second cabinet 21 may be disposed below the first cabinet 11 and support the load of the first cabinet 11. Further, the device drawer 40 may be moved backward and accommodated inside the second cabinet 21, or may be moved forward and withdrawn from the second cabinet 21.

An opening through which the device drawer 40 is moved may be formed on the front surface of the second cabinet 21. The second cabinet 21 may be a drawer-type treatment device having a height-direction length less than a width-direction length.

The device drawer 40 may be provided with a grip portion on the front surface thereof, which the user may hold. The user may withdraw the device drawer 40 by holding the grip portion provided on the front surface of the device drawer 40 accommodated inside the second cabinet 21.

The second tub 22 and the second drum 23 may be provided in the device drawer 40. At least a portion of the second tub 22 and the second drum 23 may be pulled together with the device drawer 40 out of the second cabinet 21. The second tub 22 may be provided to contain water inside it, and the second drum 23 may be provided to be rotatably installed inside the second tub 22 and accommodate laundry input through the second laundry inlet 28.

In an embodiment of the disclosure, the first treatment device 10 may be a front loader type, and the second treatment device 20 may be a top loader type. The first laundry inlet 18 of the first treatment device 10 may be located on the front surface of the first cabinet 11, and the second laundry inlet 28 of the second treatment device 20 may be located on the top surface of the device drawer 40.

The second door 29 may be provided on the top surface of the device drawer 40 to open and close the second laundry inlet 28, to which the disclosure is not limited. The second laundry inlet 28 of the second treatment device 20 may also be located on the front surface of the second cabinet 21.

The second treatment device 20 may include a second driving part 24. The second driving part 24 may be fixed to the second tub 22, the second cabinet 21, or the device drawer 40. The second driving part 24 may be connected to the second drum 23 and rotate the second drum 23.

The second treatment device 20 may include a second water supply part 25. The second water supply part 25 may be connected to the outside of the second cabinet 21 and receive water. The second water supply part 25 may be connected to the first treatment device 10 or an external water supply source to receive water.

The second treatment device 20 may include a second detergent supply part 26. The second detergent supply part 26 may be provided to supply detergent into the second tub 22, for a treatment course performed in the second treatment device 20.

The second detergent supply part 26 may store detergent separately from the first detergent supply part 16 or may receive detergent from the first detergent supply part 16 and provide the detergent to the second tub 22.

The second water supply part 25 may be directly connected to the second tub 22 and supply water into the second tub 22, or may be connected to the second detergent supply part 26 and supply water to the second detergent supply part 26, so that the second detergent supply part 26 may supply both water and detergent into the second tub 22.

The second treatment device 20 may include a second drain part 27, and the second drain part 27 may be provided to discharge water from the second tub 22 to the outside of the second cabinet 21.

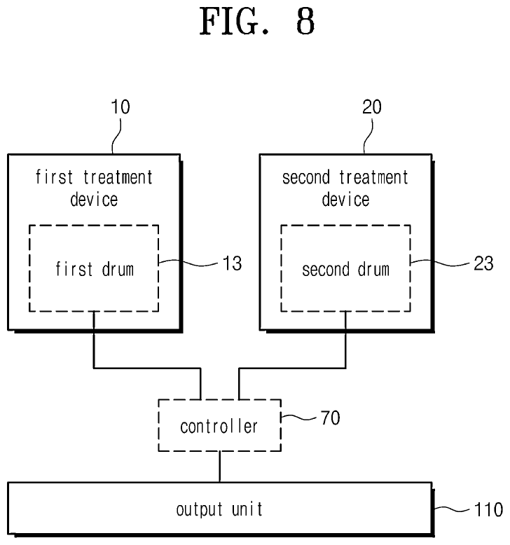

FIG. 8 is a conceptual diagram schematically illustrating a connection relationship between the controller 70 and the first treatment device 10 and second treatment device 20 in an embodiment of the disclosure.

In an embodiment of the disclosure, one or more controllers 70 may be provided. For example, the controller 70 may be provided only in one of the first treatment device 10 or may be defined to include a first controller 70 provided in the first treatment device 10 and a second controller 70 provided in the second treatment device 20.

One or more controllers 70 may be provided in any one treatment device, when needed. For example, a plurality of controllers 70 may be provided to control different power consumption devices.

For example, the controller 70 may be provided as a plurality of controllers such as a drive controller 70 for controlling a driving part, a water supply controller 70 for controlling a water supply part, a drainage controller 70 for controlling a drain part, and a panel controller 70 for controlling the control panel 100.

Further, the controller 70 may be defined as a plurality of controllers distinguished from each other from the perspective of control processing.

For example, the controller 70 may include at least one of a storage that stores information, a processor that processes information, and a communication part that performs wired or wireless communication.

In other words, although the controller 70 may be handled as a single entity in the disclosure, it may be understood as a plurality of controllers 70 from both a structural perspective and a control role perspective.

The controller 70 may control the first treatment device 10 and the second treatment device 20. The controller 70 may be provided in either the first treatment device 10 or the second treatment device 20, or in each of the first treatment device 10 and the second treatment device 20.

The controller 70 may be directly or indirectly connected to the first drum 13 of the first treatment device 10 and the second drum 23 of the second treatment device 20 to perform a first course by rotating the first drum 13 or a second course by rotating the second drum 23.

The controller 70 may be connected to an output part 110 provided in the control panel 100 and control a screen D1 output by the output part 110. A detailed description will be given later of the screen D1 output from the output part 110.

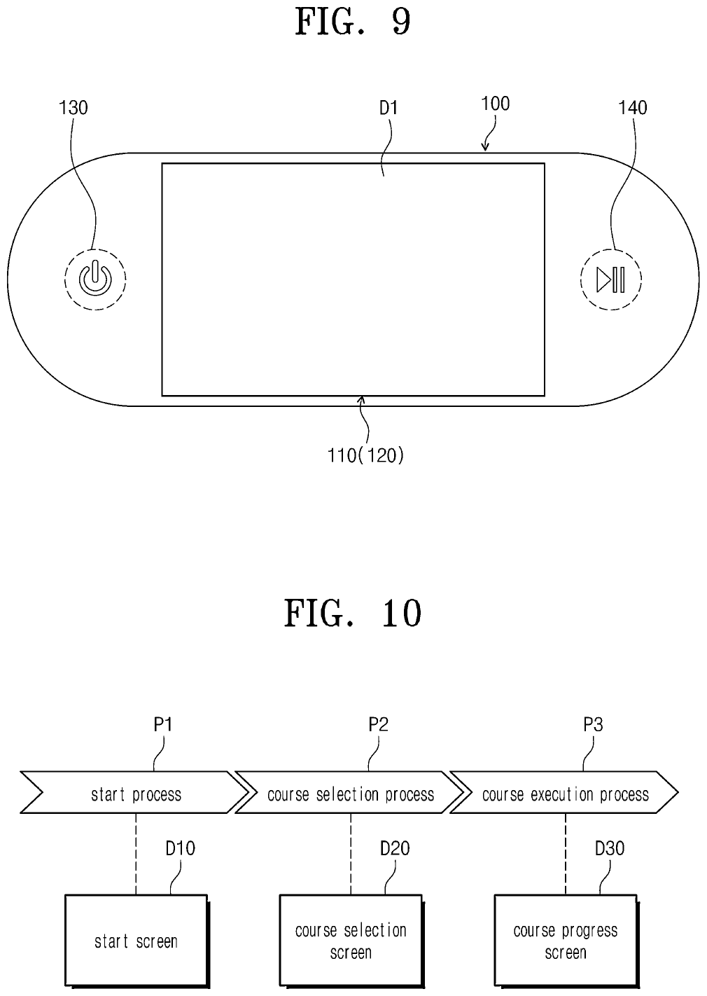

FIG. 9 is a diagram illustrating the control panel 100 according to an embodiment of the disclosure. The laundry treatment apparatus 1 according to an embodiment of the disclosure may include the input part 120 and the output part 110 as described above. The input part 120 and the output part 110 may be provided in the control panel 100, which should not be construed as limiting.

The output part 110 may output various types of information such as auditory information and visual information to be provided to the user. For example, the output part 110 may correspond to a speaker that outputs sound to provide information, or may be a screen output device that outputs a screen D1 to provide information to the user.

In an embodiment of the disclosure, the output part 110 may output various screens D1. The various screens D1 to be output from the output part 110 may be pre-stored in the controller 70. The controller 70 may control the output part 110 to change a screen D1 output from the output part 110.

In an embodiment of the disclosure, the screens D1 output from the output part 110 may include a first device screen related to the first treatment device 10 and a second device screen related to the second treatment device 20. Further, the screens D1 may include a simultaneous screen that displays information related to the first treatment device 10 and information related to the second treatment device 20 together.

A plurality of screens D1 output from the output part 110 may be distinguished from each other according to displayed information. For example, the screens D1 may include a start screen D10 that provides booting information for the first treatment device 10 or the second treatment device 20, a course selection screen D20 that displays treatment courses available for the first treatment device 10 or the second treatment device 20, an option display screen that displays option information for a treatment course, an option settings screen for setting one of a plurality of options for a treatment course, and a course progress screen D30 that displays progress information about a treatment course being performed in the first treatment device 10 or the second treatment device 20.

The plurality of screens D1 classified according to displayed information may be further classified according to the treatment devices. For example, the course selection screen D20 may be divided into a first course selection screen D20 displaying a first course of the first treatment device 10, and a second course selection screen D20 displaying a second course of the second treatment device 20.

The course progress screen D30 may include a first course progress screen D30 that displays progress information about the first course and a second course progress screen D30 that displays progress information about the second course.

The controller 70 may control the output part 110 to output any one of the first device screen related to the first treatment device 10, the second device screen related to the second treatment device 20, or the simultaneous screen that displays information about the first treatment device 10 and information about the second treatment device 20 together.

Further, the controller 70 may control the output part 110 to select any one of a plurality of screens, such as the start screen D10, the course selection screen D20, and the course progress screen D30, depending on the power states of the treatment devices or the progress state of each treatment course.

The input part 120 may be provided to receive a user command. For example, the input part 120 may generate an input signal according to the user's manipulation, and the input signal may be transmitted to the controller 70 and converted into various user commands.

In an embodiment of the disclosure, the output part 110 may display various objects on a screen D1. The various objects may be displayed to be selectable on the screen D1, and the input part 120 may receive a user command for the user to select one of the displayed objects on the screen D1.

For example, the input part 120 may be provided in the output part 110 to detect the user's touch on the screen D1. That is, the input part 120 may correspond to a touch film provided on a display on which the screen D1 is output from the output part 110.

An embodiment of the disclosure may be provided with a power button 130 and a start/pause button 140. The buttons may be of various types, such as a mechanical type or a touch type.

The power button 130 may be provided to turn on or turn off the first treatment device 10 and/or the second treatment device 20. The start/pause button 140 may be provided to allow the user to command to perform or stop the first course of the first treatment device 10 and/or the second course of the second treatment device 20.

Although the power button 130 and the start/pause button 140 may be provided for each of the first treatment device and the second treatment device, the power button 130 and the start/pause button 140 may be provided in only one of the first treatment device 10 and the second treatment device 20 in an embodiment of the disclosure.

For example, when the first treatment device 10 is provided with the power button 130 and the start/pause button 140, the second treatment device 20 may not include the power button 130 and the start/pause button 140. Further, a single power button 130 and a single start/pause button 140 may be provided in the first treatment device 10.

In this case, the single power button 130 may be used to change the power state of the second treatment device 20 as well as the power state of the first treatment device 10. The power button 130 may control the power of a user-selected treatment device of the first treatment device 10 and the second treatment device 20.

Further, the single start/pause button 140 may be used to change whether to perform/stop the second course as well as whether to perform/stop the first course. The start/pause button 140 may change whether to perform/stop a course of a user-selected treatment device of the first treatment device 10 and the second treatment device 20.

The laundry treatment apparatus 1 according to an embodiment of the disclosure may not include a device switch button to switch between the first device screen related to the first treatment device 10 and the second device screen related to the second treatment device 20 on the output part 110.

As described later, in an embodiment of the disclosure, the user may determine a treatment device to be displayed on the screen D1 by selecting either a mode related to the first treatment device 10 or a mode related to the second treatment device 20 displayed on the output part 110.

The output part 110 and/or the input part 120 may be provided on the front panel of the first cabinet 11 or second cabinet 21. The front panel may be provided with the afore-described first laundry inlet 18 or second laundry opening 28, and provided with the first door 19 or the second door 29.

For example, when the output part 110 and/or the input part 120 is provided in the first treatment device 10, the output part 110 and/or the input part 120 may be disposed on the front panel above the first door 19. The control panel 100 may have a shape extending approximately along the width direction of the first cabinet 10, and the extended length of the control panel 100 may be smaller than the width of the first cabinet 10.

However, the location of the output part 110 and/or the input part 120 is not necessarily limited to that described above. For example, the output part 110 and/or the input part 120 may be provided on the first door 19 instead of the front panel.

When the control panel 100 is provided on the first door 19, a substrate, an external panel, the input part 120, the output part 110, and so on which form the control panel 100 may be provided on the first door 19.

Even when the output part 110 and/or the input part 120 is provided in the second treatment device 20, the output part 110 and/or the input part 120 may be provided on the front panel or the second door 29 of the second cabinet 21.

The power button 130, the start/pause button 140, and the output part 110 may be provided on the control panel 100. For example, the power button 130 and the start/pause button 140 may be disposed on both sides of the output part 110 that includes the display and outputs a screen.

The power button 130 may be disposed on one side of the output part 110, and the start/pause button 140 may be disposed on the other side of the output part 110. The power button 130, the start/pause button 140, and the output part 110 may be located within the perimeter of the control panel 100, and the power button 130 and the start/pause button 140 may be in a color identical or similar to that of the control panel 100.

The power button 130 may be provided only in one of the first treatment device 10 and the second treatment device 20 and manipulated by the user. Therefore, the user may engage in power control of a plurality of treatment devices through a single manipulation, thereby increasing use convenience.

Further, the start/pause button 140 may be provided only in one of the first treatment device 10 and the second treatment device 20 and manipulated by the user. Therefore, as described later, the course progress state of the first treatment device 10 and/or the second treatment device 20 may be checked through the output part 110, and a course may be stopped or a stopped course may be resumed. This may enable an intuitive and convenient operation.

Further, either the first treatment device 10 or the second treatment device 20 may be provided with both the power button 130 and the start/pause button 140 which are operated by the user. Accordingly, the user may control start/pause and power through a single treatment device without having to remember separate locations, which may eliminate confusion.

FIG. 10 conceptually illustrates a process of operating the laundry treatment apparatus 1 according to an embodiment of the disclosure, and related screens D1 on the output part 110.

First, when the laundry treatment apparatus 1 is powered on through the power button 130, the controller 70 may perform a start process P1 of determining the normal state of various components and preparing for course execution, and the output part 110 may output the start screen D10 to notify the user of the start process P1.

After the start process P1 is completed, the controller 70 may perform a course selection process P2. A plurality of treatment courses for laundry treatment may be pre-stored in the controller 70, and the user may select one of the plurality of treatment courses in the course selection process P2.

Further, various options for the course may be adjusted by the user in the course selection process P2. The output part 110 may output the option display screen to provide option information in the course selection process P2. Further, the output part 110 may output the option settings screen to change a setting value for any one of the options of a target course to be currently performed in the course selection process P2.

In the course selection process P2, when the afore-described start/pause button 140 is manipulated with any one treatment course set as the target course to be performed, the controller 70 may perform a course execution process P3 of performing the treatment course.

In the course execution process P3, the controller 70 may perform the treatment course for which an option or the like has been determined through the course selection process P2, and the output part 110 may display the course progress screen D30 indicating the progress state of the treatment course.

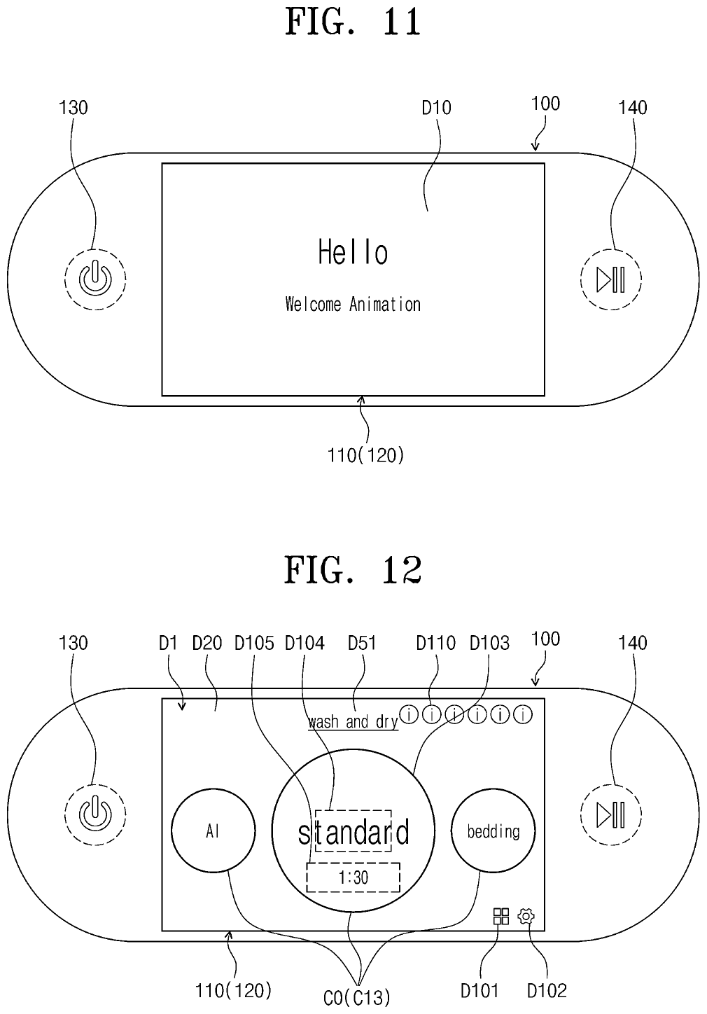

FIG. 11 illustrates the start screen D10 output from the output part 110 according to an embodiment of the disclosure. The start screen D10 may include an image notifying the user of power-on or include general information for performing a treatment course.

The screen illustrated in FIG. 11 corresponds to a welcome screen indicating power-on of the laundry treatment apparatus 1 among start screens D10. The welcome screen may be a screen D1 output from the output part 110 in an initial stage of powering on the laundry treatment apparatus 1. The welcome screen may include various phrases and images to create familiarity with the user or to notify the user of power-on.

FIG. 12 illustrates an example of the course selection screen D20. The course selection screen D20 may display the name of a target treatment course C0 to be performed among a plurality of treatment courses C0.

Specifically, at least some of the plurality of treatment courses C0 may be displayed on the course selection screen D20. The course selection screen D20 may display course objects D103 corresponding to the plurality of treatment courses C0, respectively, such that they are selectable by the user.

The user may set any one of the plurality of treatment courses C0 displayed on the course selection screen D20 as a target treatment course to be performed by a user command through the input part 120 described above.

The plurality of course objects D103 may be arranged along one direction on the course selection screen D20. For example, the plurality of course objects D103 may be arranged along the width direction, height direction, or diagonal direction of the cabinet 11.

Course objects D103 other than the course object for the target course may be disposed on one side and/or the other side of the target course. Among the plurality of course objects D103, the course object for the target course may be displayed in a larger size than the other course objects.

For example, as illustrated in FIG. 12, the plurality of treatment courses C0 may be displayed on the course selection screen D20, and one of them may displayed as a target treatment course by being disposed at the center in a larger size than the other treatment courses.

The user may change the target treatment course C0 by manipulating the input part 120, for example, by inputting a touch signal through sliding on the output part 110.

As described above, the course object D103 representing each treatment course C0 may be provided to be displayed on the course selection screen D20, and have a border line to be visually identifiable to the user.

Further, the course object D103 may include a color or image different from the remaining portion of the screen D1 except for the course object D103.

The course object D103 may include a course name D104 indicating the name of the corresponding treatment course C0, and an expected time D105 indicating an expected time that it will take to perform the treatment course C0.

When a user command, input signal, or touch signal for selecting the course object D103 is transmitted to the controller 70 through the input part 120, the controller 70 may control the output part 110 to output the option display screen displaying option information for the corresponding treatment course C0.

The user may select the course object D103 so that the option display screen is output, select one of a plurality of options displayed on the option display screen, and change a setting value for the option.

A mode selection object D51 for outputting a plurality of modes selectable in the first treatment device 10 and the second treatment device 20 on the screen D1 may be displayed on the course selection screen D20.

Specifically, in an embodiment of the disclosure, the first treatment device 10 and/or the second treatment device 20 may operate in at least one mode. For example, the first treatment device 10 may operate in any one of a wash mode in which a wash course for washing laundry is performed, a dry mode in which a dry course is performed, and a wash and dry mode in which a wash and dry course C13 is performed. The second treatment device 20 may also operate in at least one mode.

The course selection screen D20 may display treatment courses C0 according to a current operation mode among a plurality of modes including the modes of the first treatment device 10 and the second treatment device 20. FIG. 12 illustrates an example in which the wash and dry mode of the first treatment device 10 is selected, and the course selection screen D20 displays wash and dry courses C13 according to the wash and dry mode.

The mode selection object D51 may be displayed to include the name of the current mode in operation, and upon selection of the mode selection object D51, the controller 70 may control the output part 110 to output a mode selection screen which displays the plurality of modes to be selectable. A more detailed description will be given later of the plurality of modes.

Considering a limited size of the screen D1, only some of the plurality of treatment courses C0 set in the controller 70 may be displayed on the course selection screen D20. FIG. 12 illustrates a course selection screen D20 displaying some of the wash and dry courses C13 in the wash and dry mode.

The user may change the treatment courses C0 displayed on the course selection screen D20 through an input signal, for example, by sliding on the screen D1.

However, when a large number of treatment courses C0 are stored for the corresponding mode in the controller 70, it may be inconvenient for the user to check all of the plurality of treatment courses C0 by sliding or other methods.

Accordingly, the output part 110 may display a course view object D101 to output more treatment courses C0 than those displayed, at once on the course selection screen D20.

Upon user selection of the course view object D101, the output part 110 may display, on a screen, a plurality of treatment courses C0 available for the user more than those displayed on the course selection screen D20.

For example, upon selection of the course view object D101, the output part 110 may display all of a plurality of currently available treatment courses C0 to be selectable. When there are too many treatment courses C0, the plurality of treatment courses C0 may be displayed on the screen in a plurality of pages.

A settings object D102 may be displayed on the course selection screen D20. Upon user selection of the settings object D102, a settings screen for setting the first treatment device 10 or the second treatment device 20 may be displayed on a screen.

An indicator D110 may be displayed on the course selection screen D20. The indicator D110, which is an indication to indicate the state of the first treatment device 10 or the second treatment device 20, may be displayed in a shape corresponding to information to be indicated to the user.

A plurality of indicators D110 may be displayed on the screen D1 to indicate different information. For example, the plurality of indicators D110 may indicate various pieces of device information such as communication state information and reservation state information.

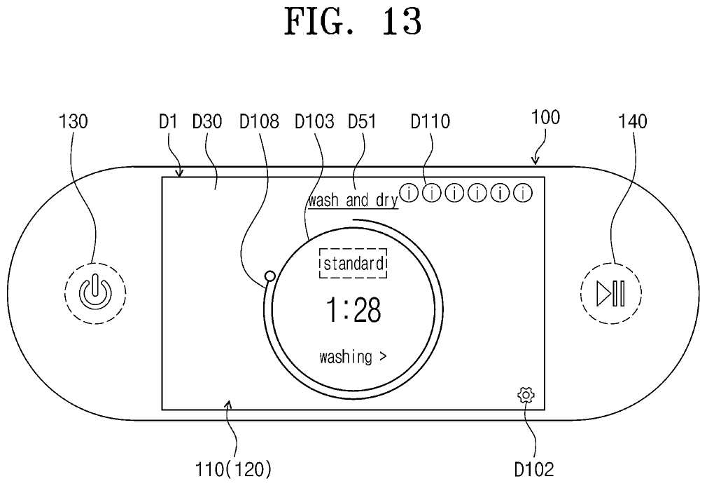

FIG. 13 illustrates the course progress screen D30 according to an embodiment of the disclosure. When the afore-described start/pause button 140 is manipulated with any one treatment course displayed as the target treatment course on the course selection screen D20, or when the start/pause button 140 is manipulated on the option display screen for any one treatment course, the controller 70 may perform the treatment course, and the output part 110 may output the course progress screen D30 indicating progress information about the treatment course.

The course progress screen D30 may include the mode selection object D51, the settings object D102, and the indicator D110 described above. Further, the course progress screen D30 may display the afore-described course object D103, and the course object D103 may include the course name D104 indicating the name of the current treatment course in progress, a remaining time D106 required to complete the current treatment course, a process description D107 to describe a current cycle in progress in the treatment course, and a time display part D108 indicating an extent to which the entire treatment course has been performed so far. The time display part D108 may display an already performed cycle and a remaining cycle or a time taken to date and a remaining time differently on a specific line corresponding to the entire treatment course, so that the user may conveniently identify the remaining cycle or time.

The following description will be given with the appreciation that the laundry treatment apparatus 1 according to an embodiment of the disclosure is the first treatment device 10 described above.

Therefore, the afore-described first cabinet 11, first door 19, first laundry inlet 18, first tub 12, first laundry container, and first drum 13, first driving part 14, first water supply part 15, first detergent supply part 16, and first drain part 17 are simply referred to as a cabinet, a door, a laundry inlet, a tub, a laundry container, a drum, a driving part, a water supply part, a detergent supply part, and a drain part, respectively.

However, this is only for convenience of description, and does not mean that the embodiments of the disclosure below exclude the case where the first treatment device 10 and the second treatment device 20 are included.

The laundry treatment apparatus 1 according to an embodiment of the disclosure includes the cabinet 11, the laundry container, the output part 110, and the input part 120. The laundry container is provided inside the cabinet 11 and accommodates laundry. The laundry container may include the drum 13. The output part 110 is provided in the cabinet 11 and outputs a screen D1. The input part 120 is provided in the cabinet 11, and receives a user command for selecting an object displayed on the screen D1.

The laundry treatment apparatus 1 according to an embodiment of the disclosure may include the controller 70, the start/pause button 140, and the driving part 14. The start/pause button 140 may be provided on the cabinet 11 and manipulated by the user, and the driving part 14 may be connected to the drum 13 and provide rotational force to the drum 13.

The time display part D108 may display an already performed cycle and a remaining cycle or a time taken to date and a remaining time differently on a specific line corresponding to the entire treatment course, so that the user may conveniently identify the remaining cycle or time.

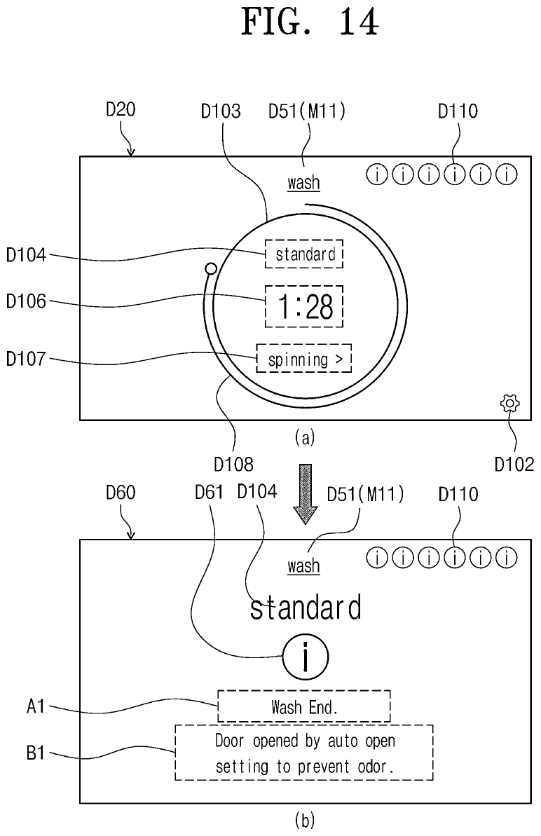

FIG. 14 illustrates a process of switching from the course progress screen D30 to a course completion screen D60 outputting a message indicating that the door 19 has been moved to the open state by the door opening part 195, after completion of a laundry treatment course.

The door 19 may be fixed to the front panel 11 by the door opening part 195. The door opening part 195 may maintain the laundry inlet 18 in the closed state by locking the door to the cabinet or switch the laundry inlet 18 to the open state by unlocking the door 19, according to a control signal from the controller 70.

When the door 19 is moved to the open state, an open message B1 notifying that the door 19 has been moved to the open state by the door opening part 195 may be output. The open message B1 may appear in a pop-up format on the course progress screen D30, or may be output on the course completion screen D60 through switching to a new window.

Switching to the open state may be notified to the user by any means, as far as it allows the user to recognize switching to the open state, such as an icon or a notification mark, not limited to text.

The open message B1 may be presented together with a mark indicating a warning or notification.

The open message B1 or means indicating the open state may be displayed together with the name of the completed course or the name of a mode. The mode selection object D51 may be displayed on the course completion screen D60. The mode selection object D51 may be displayed as text or an icon representing the mode.

The opening message B1 may be output together with a course end notification message A1 notifying the completion of the course on the course completion screen D60. The course end notification message A1 may be displayed in a way distinct from the open message B1.

For example, the course completion notification message may be displayed separately in a different color, with a different brightness, or on a different line. The course completion message may be an icon or mark, not limited to text, as far as it allows the user to recognize the completion of the course.

The course completion message may be output, inclusive of the name of the completed course or mode, to remind the user of the completed course or mode.

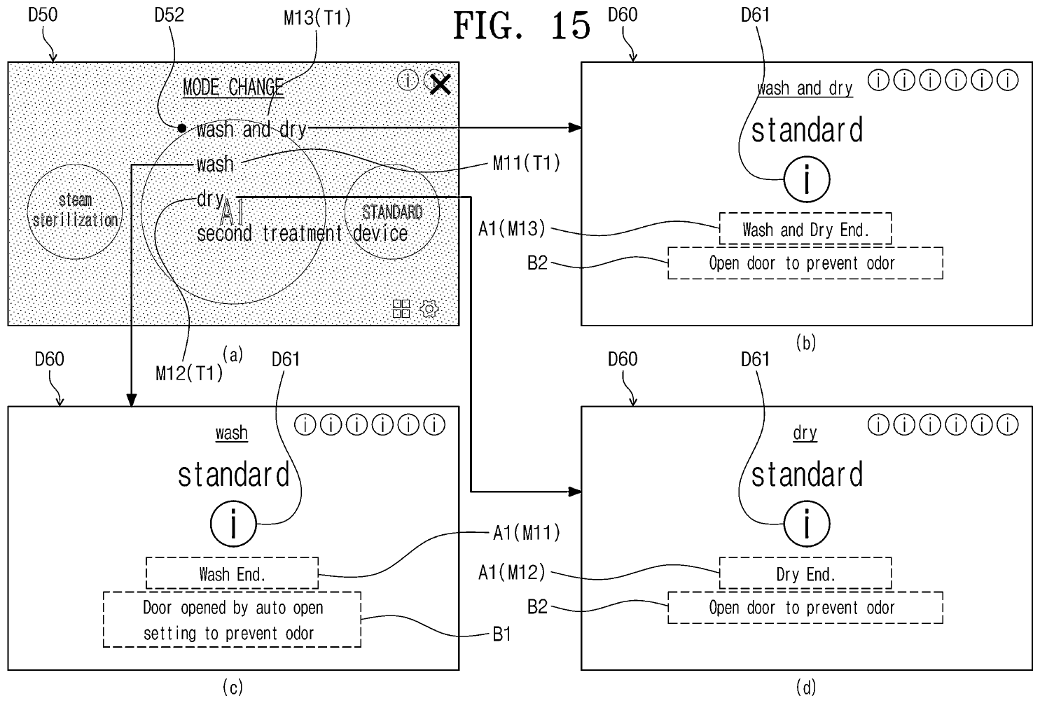

FIG. 15 is a diagram illustrating a comparison between course completion screens D60 displayed upon completion of treatment courses in respective modes in which different treatment courses may be performed in the treatment device and which are displayed on the mode selection screen D50.

In an embodiment of the disclosure, the treatment device may operate in at least one mode. For example, it may operate in any one of a wash mode M11 in which a wash course for washing laundry is performed, a dry mode M12 in which a dry course is performed, and a wash and dry mode M13 in which a wash and dry course is performed.

The wash course, the dry course, and the wash and dry course may include different cycles even if they have the same name. For example, among a plurality of wash courses, a standard course may include a water supply cycle, a detergent supply cycle, and a spin cycle, and among a plurality of dry courses, a standard course may include a dry cycle without a water supply cycle.

Therefore, the user may select an intended treatment course by selecting an operation mode of the treatment device to suit the user's needs. For example, the wash mode M11 may be selected, and one of a plurality of wash courses may be performed.

In other words, as the treatment device operates in any one of a plurality of operation modes, various treatment courses may be provided to the user, and the user may select a desired operation mode and perform a necessary treatment course.

Upon completion of a first course among the plurality of treatment courses, the door opening part 195 may move the door 19 from the closed state to the open state, and when a second course among the plurality of treatment courses is completed, the door opening part 195 may maintain the door 19 in the closed state.

When the door 19 is moved to the open state by the door opening part 195, the controller 70 may output the open message B1 notifying the user of the open state, and when the door 19 is maintained in the closed state, the controller 70 may control the output part 110 to output a recommendation message B2 recommending the user to open the door 19.

In an embodiment of the disclosure, the door 19 may be moved to the open state after the completion of the first course, and maintained in the closed state in the second course.

Control of the door opening part 195 may be selectively set by the user. In an embodiment of the disclosure, the availability of setting the door opening part 195 may be different for the first course and the second course. For the first course, the user may be allowed to set whether to operate the door opening part 195 (T1), whereas for the second course, the user may not be allowed to set whether to operate the door opening part 195.

The door opening part 195 may be operated by reflecting the user's selection by allowing the user to set whether to operate the door opening part 195 (T1). However, when opening the door 19 by the user's carelessness or ignorance after completion of a course is not appropriate for safety reasons, an accident may be prevented.

In an embodiment of the disclosure, the first course may correspond to the wash course, and the second course may correspond to the dry course. Additionally, the second course may include the wash and dry course.

Therefore, it may block a safety accident or interference with maintaining temperature, which may occur when internal air heated by the heating part 30 flows out to the outside by moving the door 19 to the open state and affects external air, after the course including the dry course is completed.

FIGS. 15(b) and 15(d) illustrate output of the recommendation message B2 because the door 19 is maintained in the closed state, after a course is completed.

The recommendation message B2 may appear in a pop-up format on the course progress screen D30, or be output on the course completion screen D60 through switching to a new window.

The recommendation message B2 recommending the user to open the door 19 is not limited to text, and any means allowing the user to recognize the recommendation is sufficient as the recommendation message B2, such as an icon or a notification mark.

The recommendation message B2 may be presented together with a mark indicating a warning or a notification.

The recommendation message B2 may be displayed together with the name of the completed course or mode. The mode selection object D51 may be displayed on the course completion screen D60. The mode selection object D51 may be displayed as text or an icon which represents the mode.

Further, the recommendation message B2 may attract the user's attention by presenting the basis for the recommendation. In an example of the disclosure, the recommendation message B2 may be more persuasive to the user by adding a phrase such as ‘to prevent odor’.

FIG. 15(c) illustrates output of the open message B1 by moving the door 19 from the closed state to the open state through the door opening part 195, after a course is completed.

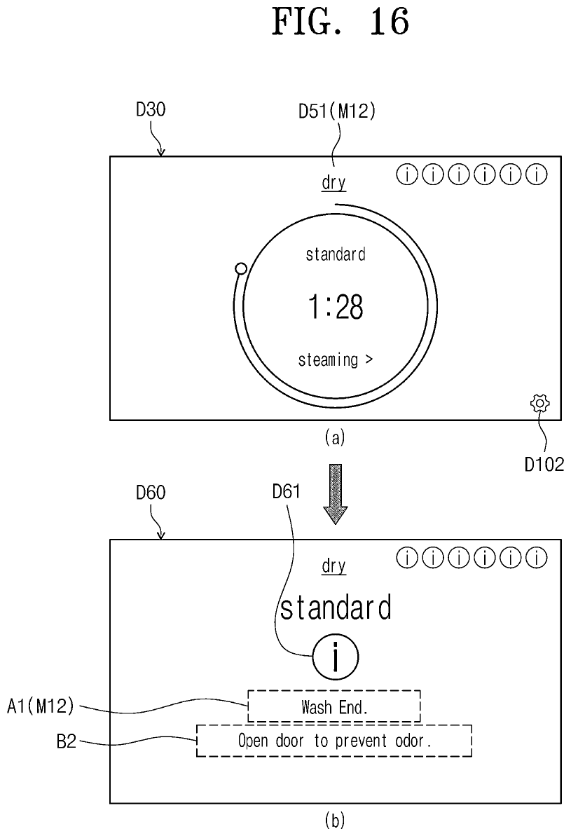

FIG. 16 is a diagram illustrating an embodiment of the disclosure in which as the dry course corresponds to the second course, the course progress screen D30 of the dry course is switched to the course completion screen D60 after the course is completed, and the course end notification message A1 and the recommendation message B2 are output.

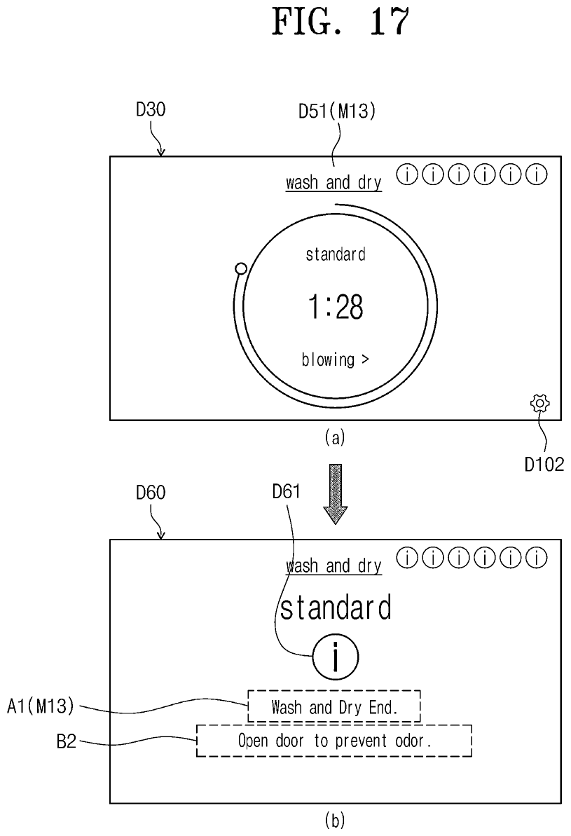

FIG. 17 is a diagram illustrating an embodiment of the disclosure in which as the wash and dry course corresponds to the second course, the course progress screen D30 of the wash and dry course is switched to the course completion screen D60 after the course is completed, and the course end notification message A1 and the recommendation message B2 are output.

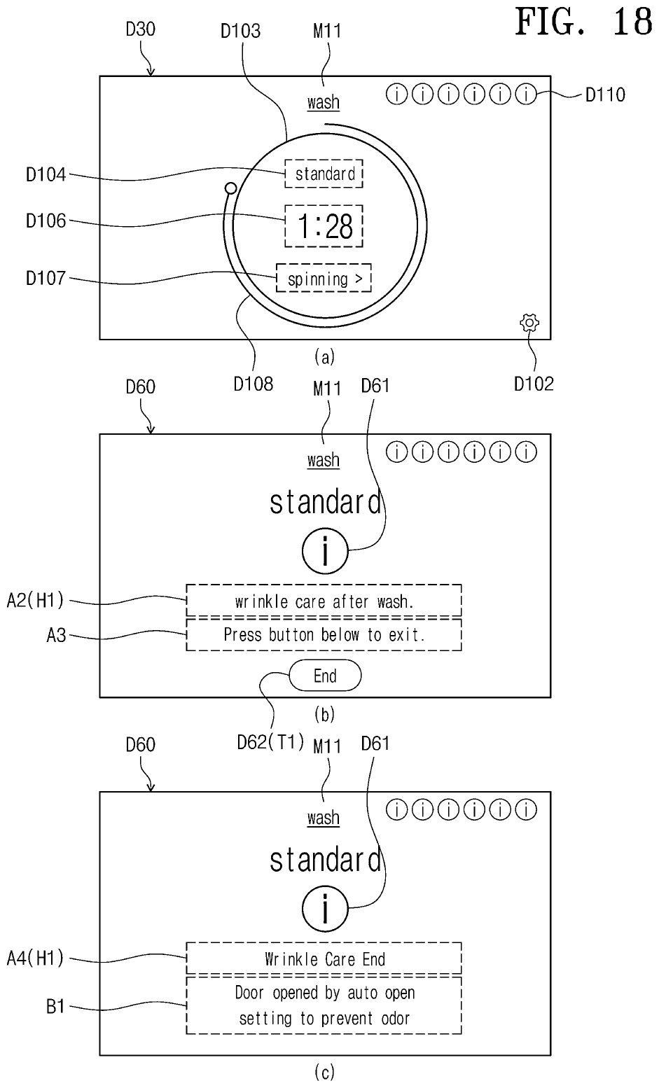

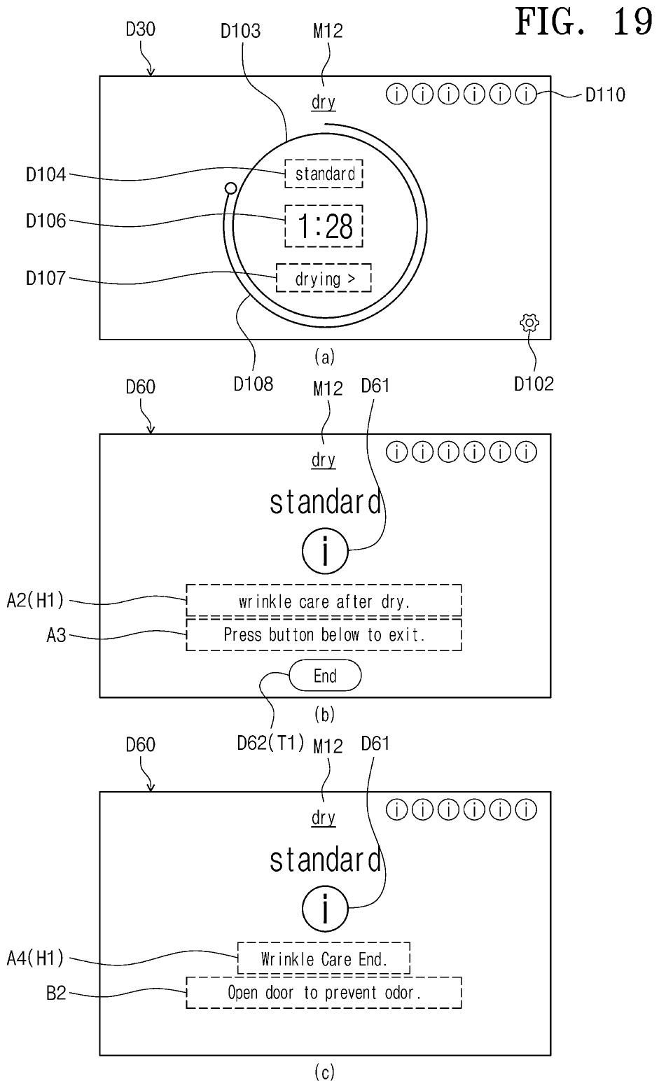

FIGS. 18 and 19 illustrate that in the case where a care course H is performed after any one of the plurality of treatment courses is completed, the care course H is performed with the door 19 maintained in the closed state after completion of the first course, and the course completion screen D60 is output indicating that the door 19 has been moved to the open state, after the care course H is completed.

Therefore, it is possible to prevent laundry from falling out of the laundry inlet 18 due to rotation of the drum during the care course H or prevent internal water from leaking to the outside during the care course H, as the door opening part 195 moves the door 19 from the closed state to the open state.

The care course H may be selectively performed, and a plurality of care courses H may be stored in the controller 70. In an embodiment of the disclosure, the care course H may include a laundry care course H2 including a rinse cycle for laundry or a wrinkle suppression course H1 that suppresses wrinkles in laundry by rotating the drum.

The laundry care course H2 may prevent odors caused by bacterial growth due to moisture in the laundry and the drum and a sealed environment after washing the laundry, and the wrinkle suppression course H1 may prevent laundry from being wrinkled due to water vapor resulting from cooling heated air inside after a laundry treatment course and the remainder of water used for laundry treatment.

The care course H may or may not be performed for each of the plurality of courses. One of the plurality of care courses H may be performed only after the first course, and the other may be performed after completing the first course or the second course.

The one care course and the other care course of the plurality of care courses H may be performed successively after the first course. In an embodiment of the disclosure, the one care course may correspond to the laundry care course H2, and the other care course may correspond to the wrinkle suppression course H1.

In an example of the disclosure, the first course may include a wash course, and the second course may include a dry course and a wash and dry course. Therefore, it is possible to prevent laundry dried after the dry course from being rinsed by the laundry care course H2.

During the care course H is in progress, the output part 110 may output a message notifying that the care course H is in progress, and after the care course H is completed, output the open message B1 or the recommendation message B2.

A care course progress message A2 notifying that the care course H is in progress may be displayed in the form of a window on a portion of the course completion screen D60 or displayed on a full screen D1. In addition, the care course progress message A2 may be an icon or mark, not limited to text, as far as it is recognizable to the user.

The care course progress message A2 may include the name of the completed course. In an embodiment of the disclosure, the care course progress message A2 may be added with a phrase such as ‘after washing is finished’, so that the user may conveniently recognize the completed treatment course and the ongoing care course H in the current treatment device.

The care course progress message A2 may be displayed together with an end setting object D62 to stop the care course H, and the end setting object D62 may be displayed to be selectable through the input part 120 which is manipulated by the user to generate an input signal.

The end setting object D62 may be represented as an icon or a mark, and may be output together with an end notification mark D61 and a care course end setting message A3 to remind the user of the meaning of the end setting object D62.

Further, as the care course progress message A2, the care course end setting message A3, and the end setting object D62 may be output on one screen D1, the user may more easily identify the completed treatment course and the ongoing care course H and determine whether to end the care course H.

Upon selection of the end setting object D62 by the input part 120, the controller 70 may terminate the care course H to increase the user's satisfaction with laundry treatment.

After the care course H is completed, the output part 110 may output the open message B1 or the recommendation message B2.

In an embodiment of the disclosure, upon completion of the care course H performed after the first course among the plurality of treatment courses is completed, the open message B1 may be output, and upon completion of the care course H performed after the second course is completed, the recommendation message B2 may be output.

The open message B1 and the recommendation message B2, which are output after the care course H is completed, may be displayed together with a care course completion message A4. Further, the name of the course or mode may be displayed on the course completion screen D60 that outputs the open message B1 or the recommendation message B2. Therefore, the user may view the overall laundry treatment process including the completed treatment course and care course H at a glance.

The care course completion message A4 may be an icon or a mark, not limited to text, as far as it is recognizable to the user. Further, the care course completion message A4 and the open message B1 or recommendation message B2 may be displayed distinguishably from each other. For example, they may be displayed in different colors, on lines with a gap in between, in vertical alignment, with different brightnesses, or the like.

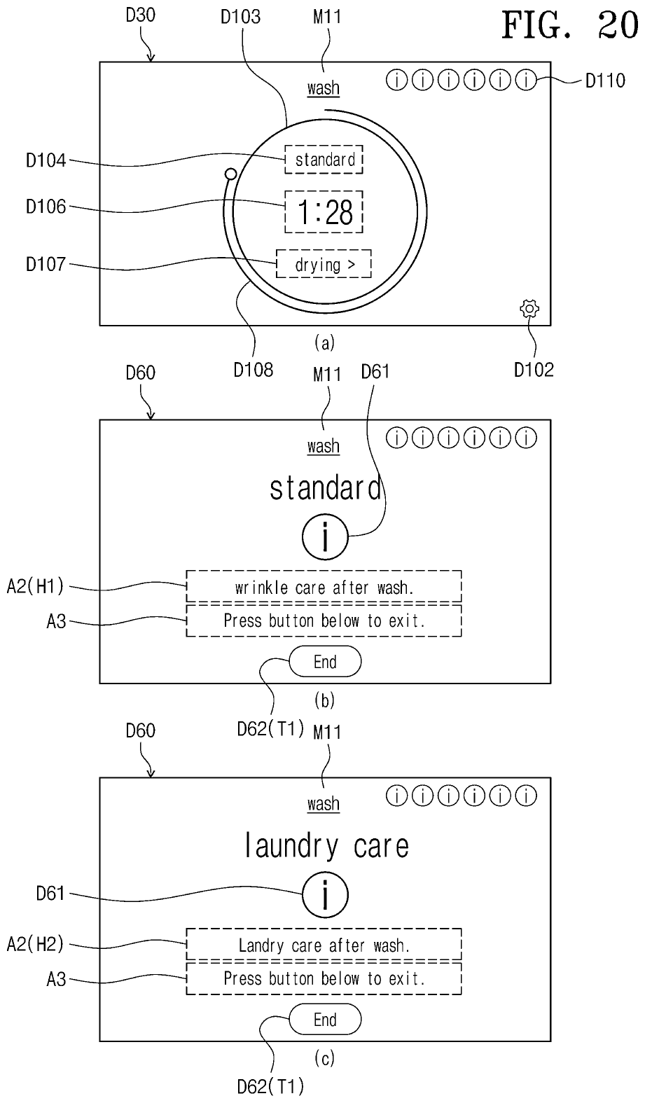

FIG. 20 illustrates that in the case where the care course H is performed after any one of the plurality of treatment courses is completed, the care course H is performed with the door 19 maintained in the closed state after completion of the second course, and the course completion screen D60 is displayed, which outputs the recommendation message B2 recommending movement of the door 19 to the open state after completion of the care course H.

In an embodiment of the disclosure, the second course may include a dry course or a wash and dry course, and the name of the second course or the name of a mode in which the second course is available may be output on the course completion screen D60 displayed after the second course is completed.

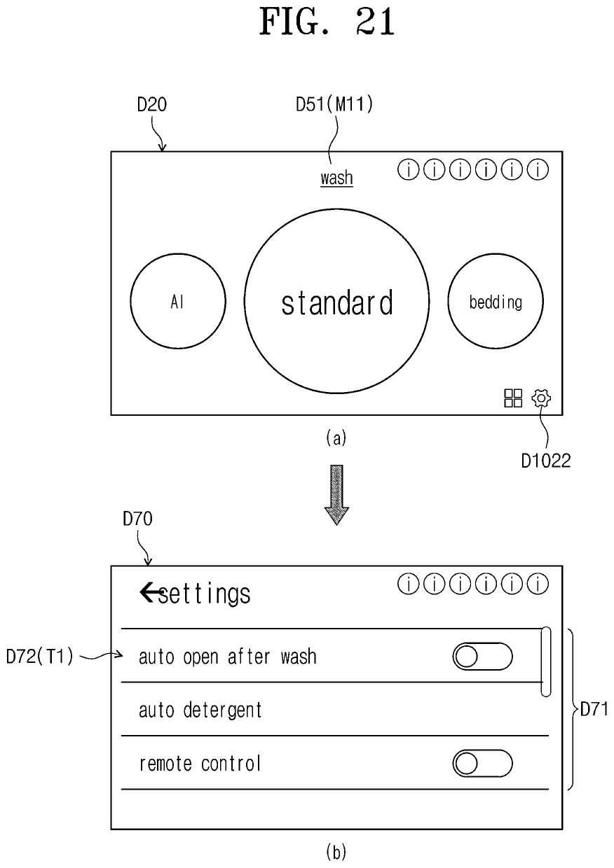

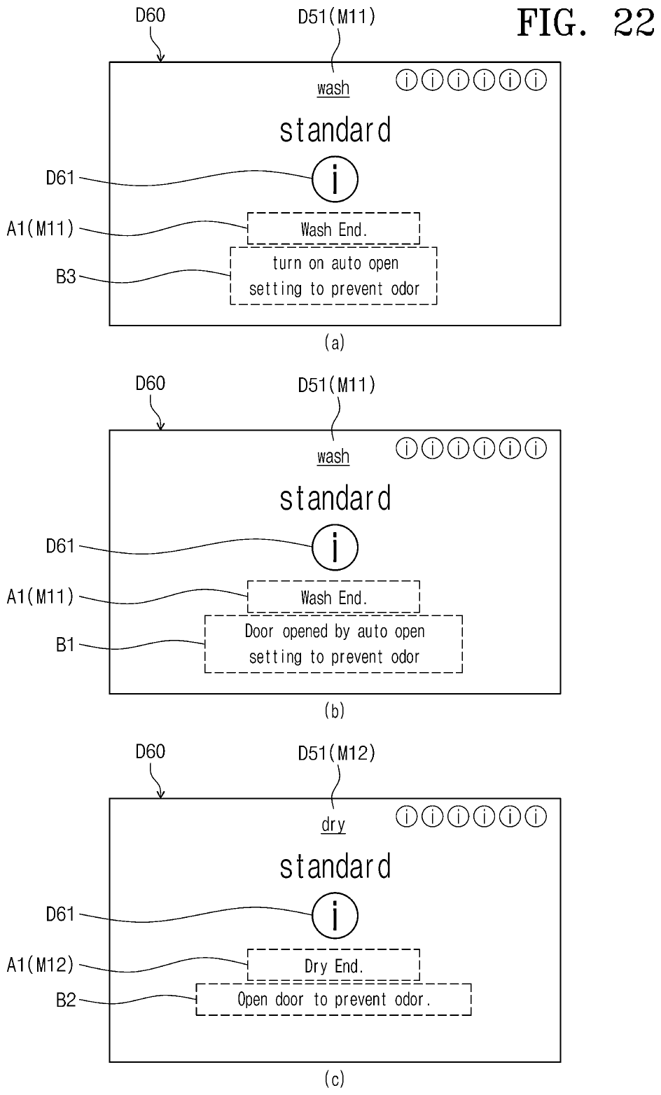

FIG. 21 illustrates a settings screen D70 that displays a plurality of setting items, upon selection of the settings object output on the course selection screen D20.

The course selection screen D20 is only an embodiment of the disclosure, and a screen D1 output on the output part 110 is sufficient as the course selection screen D20, such as the course progress screen D30, the start screen D10, the mode selection screen D50, and the course completion screen D60.

The settings object may be displayed as any one of text, an icon, a pop-up, or the like which represents the meaning of settings to the user, and selected by the input part 120 which is provided on the cabinet and manipulated by the user to generate an input signal.

Upon selection of the settings object, the settings screen D70 may be displayed on a full screen D1 or in a small pop-up notification window in an overlap format occupying a portion of the screen D1.

The settings screen D70 may output a settings list D71 including a plurality of setting items which may allow the user to change or select settings for the treatment device. The names and values of the setting items may be displayed side by side. The values of the settings may be displayed as ON/OFF switches or setting button shapes as well as text. When the setting items exceed the output part 110, a scroll bar may be provided.

When there is a current set value, the settings screen D70 may be output to be located in the second setting item. Therefore, the user may most efficiently recognize the set value without any additional manipulation.

However, exceptions are made for cases where it may not be placed as the second setting item due to its location, such as the case where when the first setting item is set, it is located at the very first place, the case where when the last setting item is set, it is located at the very end, and the case where when the second to last setting item is set, it is located as the second to last setting item.

An indicator D110 indicating state information or setting information about a treatment device to which a selected settings object belongs may be output on the settings screen D70.

The setting list D71 on the setting screen D70 may include a setting item D72 for the door opening part 195. The name of the setting item D72 for the door opening part 195 may be displayed to indicate that the setting item D72 may be set only for the first course, thereby preventing user confusion.

In an embodiment of the disclosure, the setting item D72 for the door opening part 195 may include text ‘after washing’, to imply that the door opening part 195 may move the door 19 from the closed state to the open state only after the wash course, which is an example of the first course.

Further, in the case of the second course, a different settings screen D70 may be output for each course, so that the setting item D72 for the door opening part 195 is not output on the settings screen D70, upon selection of a settings object on a device screen D1 related to the second course.

In an embodiment of the disclosure, whether to operate the door opening part 195 may be set by the user only for the first course. For the second course, it may not be possible to set whether to operate the door opening part 195, and regardless of the setting, the door opening part 195 may maintain the door 19 in the closed state after a laundry treatment course or a care course H is completed.

For the first course, only when the user sets whether to operate the door opening part 195, the controller 70 may control the door opening part 195 to move the door 19 to the open state after completion of the first course.

Further, the user is not allowed to set whether to operate the door opening part 195 for the second course, and the door 19 may be maintained in the closed state after completion of the second course, as described above.

In an embodiment of the disclosure, upon selection of the setting item D72 for the door opening part 195 in the settings list D71 on the settings screen D70 during the second course in progress, the setting item D72 may not be set, while a message notifying that the setting item D72 has been selected may be output only for the first course.

Therefore, although whether to operate the door opening part 195 is set to reflect the user's intention, moving the door 19 to the open state by operating the door opening part 195 may be prevented, when it is inappropriate for safety reasons.

FIG. 22 illustrates the course completion screen D60 on which the open message B1 or the recommendation message B2 is output after completion of a laundry treatment course, depending on whether to operate the door opening part 195 is set.

FIG. 22(b) illustrates the course completion screen D60 on which the open message B1 is output together with the course end notification message A1 after completion of the first course, when the setting item D72 for the door opening part 195 is selected.

FIG. 22(c) illustrates the course completion screen D60 on which the recommendation message B2 is output together with the course end notification message A1 after completion of the second course.

In FIG. 22(a), when the door opening part 195 is set to be inoperable for the first course, a message recommending the user to set the door opening part 195 to be operable is output on the output part 110. For convenience of description, this message will be referred to as a door opening part activation recommendation message B3.

The door opening part activation recommendation message B3 may be output regardless of the progress of the first course, and output at the start of the first course, during the first course in progress, or after completion of the first course.

Preferably, after completion of the first course, the door opening part activation recommendation message B3 may be output simultaneously with notifying the completion of the course, to remind the user of the need to open the door and make the user aware of the existence of an automatic door opening setting function.

The door opening part activation recommendation message B3 may be displayed as text or an icon recommending setting of the door opening part 195. In an embodiment of the disclosure, it may include a phrase such as ‘turn on the automatic door opening setting’. Therefore, the user may recognize that the door 19 may be moved to the open state without direct user intervention by setting the door opening part 195 after completion of the course.

Further, the door opening part activation recommendation message B3 may attract the user's attention by also presenting the basis for the need for setting the door opening part 195 to be operable. In an example of the disclosure, the door opening part activation recommendation message B3 added with a phrase such as ‘prevent odor’ may be more persuasive to the user.

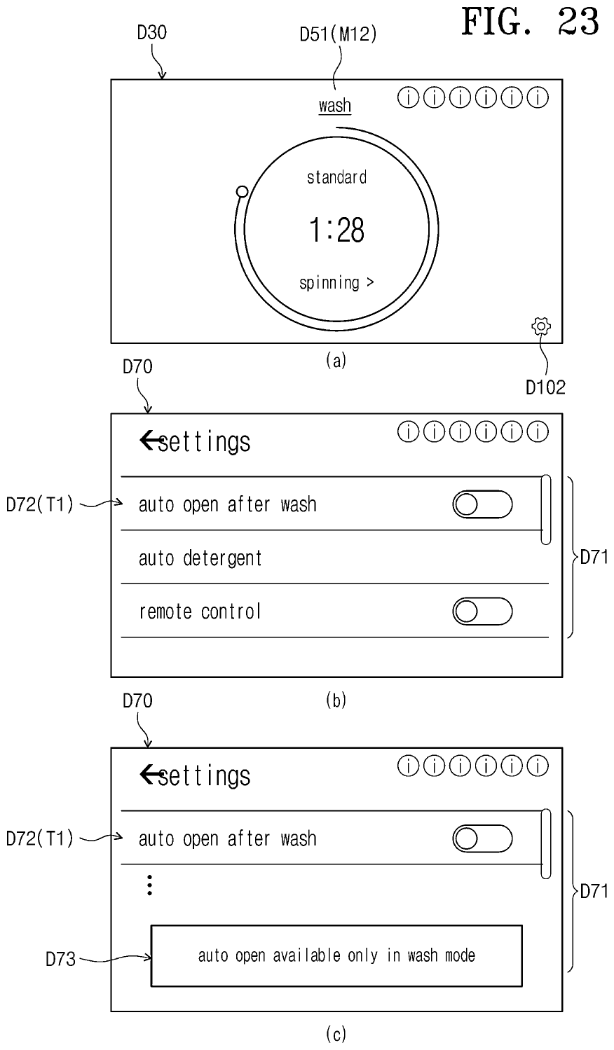

In FIG. 23, upon selection of the setting item D72 for the door opening part 195, the output part 110 outputs a message notifying the user that the door opening part 195 operates only in the first mode, or a message notifying the user that the door opening part 195 does not operate in the second mode.

For convenience of description, the above message is referred to as a setting item unavailable message D73. The setting item unavailable message D73 may include a phrase indicating that the above setting item is not available or a phrase indicating a case in which the setting item is available.

The setting item unavailable message D73 may be a picture, an icon, or a mark, not limited to text, as far as it is recognizable to the user. Further, the setting item unavailable message D73 may be displayed alone on a separate screen D1 or in a notification window or the like.

Further, the setting item unavailable message D73 may include a reason why the setting item is not available. In an embodiment of the disclosure, the reason why the setting item is not available may be recognizable to the user by including ‘only in the wash mode M11’ in the setting item unavailable message D73.

Aside from the setting item unavailable message D73, a settings object for the door opening part 195 may be switched to a selected state. In an embodiment of the disclosure, it may not be possible to set whether to operate the door opening part 195 for the second course, or regardless of whether the setting is performed, the door opening part 195 may maintain the door 19 in the closed state after the second course is completed.

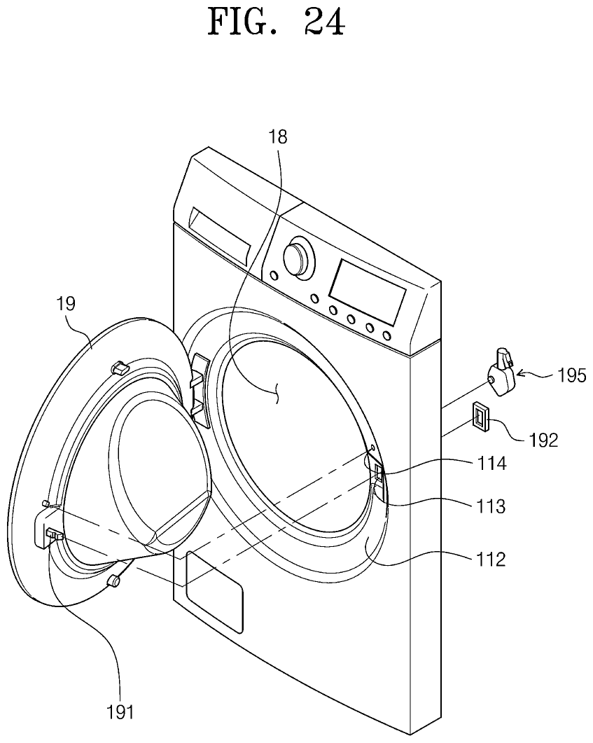

FIG. 24 illustrates the door opening part 195. In an embodiment of the disclosure, the door opening part 195 may include a base fixed to the cabinet and a protrusion of a variable length protruding from the base toward the door 19, and the controller 70 may control the door opening part 195 to move the door 19 to the open state by increasing the length of the protrusion in the closed state of the door 19.

The door 19 may be provided to include the protrusion 191 on the door 19 and a detachable portion 192 provided inside the cabinet and detachably coupled to the protrusion 191.

The protrusion 191 may be provided with a bar protruding from the door 19 toward the front panel and a fixing hole provided at a free end of the bar.

A door mounting groove 112 may be provided with a protrusion through hole 113 into which the protrusion 191 is inserted, and the detachable portion 192 may be provided to be coupled to the fixing hole inserted into the cabinet through the protrusion through hole 113.

As is apparent from the foregoing description, embodiments of the disclosure may provide a laundry treatment apparatus that increases satisfaction with laundry treatment by notifying a user whether a door has been opened after a laundry treatment course is completed.

Embodiments of the disclosure may provide a safe laundry treatment apparatus by allowing a different setting regarding whether to operate a door opening part for each laundry treatment course.

Embodiments of the disclosure may provide a laundry treatment apparatus that increases satisfaction with laundry treatment by outputting a message notifying that a door has been opened by a door opening part after a course is completed.

Embodiments of the disclosure may provide a laundry treatment apparatus that increases satisfaction with laundry treatment by outputting a different message according to a user's setting regarding whether to operate a door opening part.

Embodiments of the disclosure may provide a laundry treatment apparatus that increases satisfaction with laundry treatment by notifying whether a door has been open after a message notifying that a care course is in progress, when an additional care course is performed after a laundry treatment course.

What is claimed is:

1. A laundry treatment apparatus comprising:
a cabinet including a laundry inlet;
a drum provided inside the cabinet and accommodating laundry input through the laundry inlet;
a driving part connected to the drum and providing rotational force to the drum;
a door provided movably in the cabinet and moved to correspond to one of a closed state in which the laundry inlet is closed and an open state in which the laundry inlet is open;
a door opening part provided in the cabinet and moving the door from the closed state to the open state; and
a controller provided inside the cabinet to control the door opening part,
wherein the controller performs one of a plurality of laundry treatment courses by controlling the driving part to rotate the drum, controls the door opening part to move the door from the closed state to the open state, when a first course among the plurality of laundry treatment courses is completed, and maintains the door in the closed state, when a second course different from the first course among the plurality of laundry treatment courses is completed.

2. The laundry treatment apparatus of claim 1, wherein with whether to operate the door opening part for the first course set by a user, the controller controls the door opening part to move the door to the open state after the first course is completed.

3. The laundry treatment apparatus of claim 1, wherein the plurality of laundry treatment courses include a wash course for washing laundry and a dry course for drying laundry, and
wherein the first course corresponds to the wash course, and the second course corresponds to the dry course.

4. The laundry treatment apparatus of claim 3, wherein the plurality of laundry treatment courses further include a wash and dry course for successively washing and drying laundry, and
wherein the second course corresponds to the dry course or the wash and dry course.

5. The laundry treatment apparatus of claim 1, wherein after one of the plurality of laundry treatment courses is completed, the controller selectively performs a care course for caring laundry processed by the one laundry treatment course, and
wherein when the care course is performed after the first course, the controller perform the care course, while maintaining the door in the closed state after the first course is completed, and moves the door to the open state after the care course is completed.

6. The laundry treatment apparatus of claim 5, wherein a plurality of care courses are stored in the controller, and
wherein one of the plurality of care courses is available only after the first course, and another one is available after the first course or the second course is completed.

7. The laundry treatment apparatus of claim 6, wherein the one of the plurality of care courses corresponds to a laundry care course including a rinse cycle for the laundry after the first course is completed.

8. The laundry treatment apparatus of claim 6, wherein the other one of the plurality of care courses corresponds to a wrinkle suppression course suppressing wrinkles of the laundry by rotating the drum after the first course or the second course is completed.

9. The laundry treatment apparatus of claim 6, wherein the plurality of care courses include a laundry care course including a rinse cycle for the laundry and a wrinkle suppression course suppressing wrinkles of the laundry by rotating the drum, and
wherein when the care courses include both the laundry care course and the wrinkle suppression course, the controller performs the wrinkle suppression course after the laundry care course is completed.

10. The laundry treatment apparatus of claim 1, further comprising an output part provided in the cabinet and outputting a screen,
wherein when the door is moved to the open state by the door opening part, the controller controls the output part to output an open message notifying a user of the open state, and when the door is maintained in the closed state, the controller controls the output part to output a recommendation message recommending the user to open the door.

11. The laundry treatment apparatus of claim 10, further comprising an input part provided in the cabinet and generating an input signal by being manipulated by the user,
wherein the output part outputs a settings object selected based on the input signal, and upon selection of the settings object, outputs a settings screen displaying a plurality of setting items, and
wherein the plurality of setting items include a setting item for setting whether to operate the door opening part.

12. The laundry treatment apparatus of claim 11, wherein the setting item for setting whether to operate the door opening part is set by the input part, only when the first course among the plurality of processing courses is performed.

13. The laundry treatment apparatus of claim 11, wherein when the door opening part is set to be inoperable for the first course, the output part outputs a message recommending the user to set the door opening part to an operable state.

14. The laundry treatment apparatus of claim 1, further comprising an output part provided in the cabinet and outputting a screen,
wherein the output part outputs a message recommending a user to set the door opening part to an operable state, after the first course is completed.

15. The laundry treatment apparatus of claim 11, wherein the controller performs one of a first mode in which the first course is available and a second mode in which the second course is available, and
wherein upon selection of the setting item for setting whether to operate the door opening part, the output part outputs a message notifying the user that the door opening part is operable only in the first mode or that the door opening part is inoperable in the second mode.
